(19) United States
(12) Patent Application Publication
(10) Pub. No.: US 2023/0399719 A1
(43) Pub. Date: Dec. 14, 2023

(54) PROCESS FOR RECOVERING PRECIOUS METAL FROM AN AQUEOUS SOLUTION

(71) Applicant: CLEAN MINING PTY LTD., East Perth, Western Australia (AU)

(72) Inventor: Xianwen DAI, Aubin Grove, Western Australia (AU)

(73) Assignee: CLEAN MINING PTY LTD., East Perth, Western Australia (AU)

(21) Appl. No.: 18/034,848

(22) PCT Filed: Oct. 29, 2021
(86) PCT No.: PCT/AU2021/051265

§ 371 Date: May 1, 2023

(30) Foreign Application Priority Data
Oct. 30, 2020 (AU) 2020903947
Dec. 3, 2020 (AU) AU2020904475
Dec. 21, 2020 (AU) AU2020904771

(51) Int. Cl. C22B 11/00; C22B 3/46; C22B 3/04; C22B 3/42

(52) U.S. Cl. CPC C22B 11/04; C22B 3/46; C22B 3/04; C22B 3/42

(57) ABSTRACT

The invention provides a process for recovering precious metal from an aqueous solution comprising thiosulfate and at least one precious metal selected from gold and silver, the process comprising: introducing a soluble reducing agent to the aqueous solution in excess of any oxidants present in the aqueous solution; contacting the aqueous solution with a cementation substrate comprising a metallic composition comprising a base metal, wherein the precious metal is reduced in the presence of the reducing agent and the cementation substrate so that reduced precious metal deposits on the cementation substrate to form a precious metal cementation product; separating the precious metal cementation product from a precious metal-lean aqueous solution comprising the thiosulfate; and recovering precious metal from the precious metal cementation product.

### TECHNICAL FIELD

The invention relates to a process for recovering precious metal from an aqueous solution comprising thiosulfate and at least one precious metal selected from gold and silver. The process comprises introducing a soluble reducing agent to the aqueous solution in excess of any oxidants present, and depositing precious metal on a cementation substrate which comprises a metallic composition comprising a base metal. The process is particularly applicable to the recovery of precious metal from hydrometallurgical process streams in thiosulfate leach operations, such as pregnant leach solutions and eluates from absorbents such as ion-exchange resins, and it will be convenient to describe the invention in the context of these exemplary embodiments.

### BACKGROUND OF INVENTION

Gold cyanidation has historically been the primary hydrometallurgical technique used to extract gold from gold-bearing ores and concentrates. However, there are now strong incentives to develop alternative technologies which avoid the use of highly toxic cyanide. Thiosulfate-based lixiviants are considered a particularly promising candidate for cyanide-free gold leaching. Not only does thiosulfate leaching avoid or mitigate the environmental, safety and regulatory issues associated with cyanide, but it also offers the potential for improved performance with certain ores. For example, “preg-robbing” ores contain carbonaceous matter which strongly absorbs gold cyanide complexes, whereas gold-thiosulfate complexes are less susceptible to retention.

One challenging requirement for a competitive thiosulfate-based technology is the efficient and economic recovery of gold from gold-bearing thiosulfate solutions. Absorption onto activated carbon, a preferred technique for cyanidation process solutions, is ineffective due to the low affinity of gold-thiosulfate complexes. Direct electrowinning of pregnant leach solutions is unfavourable due to extremely low current efficiencies as a result of competitive reduction reactions (e.g. reduction of oxidant and hydrogen evolution) and destruction of reagents (e.g. oxidation of thiosulfate at the anode).

Ion-exchange technology, involving sequential absorption and elution of gold-thiosulfate complexes on a basic anion-exchange resin, is currently favoured for gold recovery from thiosulfate-based pregnant leaching solutions (PLS's). Strong base ion-exchange resins absorb gold-thiosulfate complexes strongly, permitting high recoveries even from low concentration solutions. Various methods have also been developed to efficiently and selectively elute gold from the loaded resin. For example, after a pre-elution step to desorb co-adsorbed species (such as copper-thiosulfate complexes), gold can be eluted using a two-component eluant as disclosed in WO07/137325 and recovered from the eluate using electrowinning.

While ion-exchange technology can be effective in some scenarios, it involves significant process complexity and costs which may be unacceptable for small- and medium-scale mining operations in particular. Moreover, electrowinning of resin eluates still suffers from significant disadvantages. These can include undesirable electrochemical reactions of valuable reagents in the eluate, such as thiosulfate and sulfite, generation of by-products which are detrimental when the barren eluate is recycled, and low current efficiencies.

It would therefore be desirable to develop technology capable of directly recovering gold from thiosulfate PLS without the need for an absorption step, or for efficiently recovering gold from eluates containing gold-thiosulfate complexes.

Cementation technology, which involves the deposition of metallic gold on a high surface area base metal substrate by a displacement reaction, is another commercial technique for gold recovery from cyanidation process streams. However, there are significant difficulties associated with the use of cementation to recover gold from thiosulfate-based PLS or ion-exchange resin eluate. The process introduces significant quantities of base metal species into the barren thiosulfate solution, which can be detrimental when the solution is recycled. For example, extraneous base metals can destabilise the oxidant in the leach solution, or increase the consumption of thiosulfate. Moreover, base metal cementation substrates are susceptible to passivation in thiosulfate-based solutions. This inhibits the displacement reaction, resulting in low gold recoveries and/or low gold content in the cementation product. It has therefore been concluded that cementation technology is not well suited for thiosulfate leaching applications (e.g. by Bin Xu et al, Metals 2017, 7, 222).

While the above discussion relates to gold recovery in particular, similar considerations apply to the recovery of silver from silver-bearing thiosulfate solutions. It has been reported in GB patent 1371563 that desilvering a high concentration photographic bleach-fix bath solution by cementation on iron can be improved by pre-reducing a portion of the oxidants in a preceding process step. While this approach addresses the formation of undesirable iron by-products, the residual oxidants present after the pre-treatment will still inhibit cementation. Pre-reduction of oxidants, by itself, is not adequate to achieve high precious metal recoveries and/or selective cementation in many precious metal recovery processes, particularly in hydrometallurgical processes where the initial precious metal concentrations in solution are low.

There is therefore an ongoing need for a process for recovering precious metal from an aqueous solution comprising thiosulfate and at least one precious metal selected from gold and silver, which at least partially addresses one or more of the above-mentioned short-comings, or provides a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

The present invention is based on the unexpected finding that precious metals can be recovered with excellent efficiency from precious metal-bearing thiosulfate solutions when a soluble reducing agent and base metal cementation substrate are used in combination. The precious metal can be deposited on the cementation substrate with high rates and near-quantitative selectivity, and the resultant cementation product can thus be separated easily from the barren solution and processed by conventional means to recover the precious metal.

By contrast, the base metal cementation substrate and the reducing agent are generally unsatisfactory for recovering precious metal from thiosulfate solutions when used individually. In at least some cases, the soluble reducing agent may be capable of homogeneously reducing the precious metal species present in solution, but this produces a fine precipitate which is challenging to recover. Moreover, the kinetics of the homogeneous reduction process may be unsatisfactory.

Surprisingly, it has now been found that soluble reducing agents can induce highly selective cementation of precious metal on a base metal substrate even when the soluble reducing agent is expected to be a stronger reducing agent than the base metal. The soluble reducing agent and base metal thus synergistically cooperate to heterogeneously reduce the precious metal species present in solution and deposit the precious metal on the cementation substrate.

If the precious metal-bearing thiosulfate solutions contains oxidants, as is common in leach solutions, the soluble reducing agent should be added in excess of the oxidants. Reduction of the oxidants by the soluble reducing agent is expected to occur before precious metal reduction commences, and this in itself is considered useful. However, it is important that residual reducing agent remains present during the subsequent precious metal cementation process to ensure that the benefits of synergistic reductant-mediated cementation are obtained.

The process has been found suitable for precious metal recovery from realistic thiosulfate-based hydrometallurgical process streams, including pregnant leach solutions and ion-exchange resin eluates. Thus, the deposition chemistry is compatible with the solutes typically present in such process streams, and the reduction by-products can be tolerated or are even beneficial when the precious metal lean solution is recycled. In some embodiments, the soluble reducing agent is dithionite, which has been found particularly compatible with thiosulfate-based hydrometallurgical processes for gold and silver recovery.

In accordance with a first aspect the invention provides a process for recovering precious metal from an aqueous solution comprising thiosulfate and at least one precious metal selected from gold and silver, the process comprising: introducing a soluble reducing agent to the aqueous solution in excess of any oxidants present in the aqueous solution; contacting the aqueous solution with a cementation substrate comprising a metallic composition comprising a base metal, wherein the precious metal is reduced in the presence of the reducing agent and the cementation substrate so that reduced precious metal deposits on the cementation substrate to form a precious metal cementation product; separating the precious metal cementation product from a precious metal-lean aqueous solution comprising the thiosulfate; and recovering precious metal from the precious metal cementation product.

In some embodiments, the aqueous solution is a hydrometallurgical process stream, for example a minerals processing or e-waste processing hydrometallurgical process stream.

In some embodiments, the aqueous solution comprises the precious metal in an amount of less than 2000 ppm, or less than 1000 ppm.

In some embodiments, the aqueous solution comprises one or more oxidants and the aqueous solution is contacted with the cementation substrate before depleting the one or more oxidants with the soluble reducing agent.

In some embodiments, at least 70%, or at least 80%, or at least 90%, of the precious metal reduced in the presence of the reducing agent and the cementation substrate is present in the precious metal cementation product.

In some embodiments, the precious metal comprises gold.

In some embodiments, the soluble reducing agent has a standard reduction potential (E⁰) in the range of −1.7V to +0.4V, preferably in the range of −1.3V to +0.15V.

In some embodiments, the soluble reducing agent is selected from the group consisting of dithionite, ascorbic acid, borohydride, hydrazine, hydroxylamine, and combinations thereof. In some embodiments, the soluble reducing agent comprises dithionite.

In some embodiments, the soluble reducing agent is introduced to the aqueous solution in an amount in the range of 0.1 mmol/litre to 50 mmol/litre, such as in the range of 1 mmol/litre to 20 mmol/litre.

In some embodiments, the base metal is selected from iron, copper, aluminium, nickel and zinc. In some embodiments, the metallic composition comprises a base metal selected from iron, aluminium and nickel. In some embodiments, the metallic composition comprises iron. The iron may be present as iron metal, iron alloy or steel.

In some embodiments, the metallic composition is configured as a plate, rod, powder, mesh or wool.

In some embodiments, the aqueous solution comprising thiosulfate and at least one precious metal is a pregnant leach solution.

In some embodiments, the pregnant leach solution comprises thiosulfate in a concentration of from 0.02 mol/litre to 1 mol/litre, such as from 0.1 mol/litre to 0.3 mol/litre.

In some embodiments, the pregnant leach solution comprises at least one oxidant selected from Fe(III), Cu(II) and O₂. In some embodiments, the pregnant leach solution comprises an oxidant selected from Cu—NH₃ and Fe-EDTA.

In some embodiments, the process further comprises recycling at least a portion of the precious metal-lean aqueous solution to a thiosulfate-based lixiviant for leaching precious metal from a precious metal-bearing solid material.

In some embodiments, the aqueous solution comprising thiosulfate and at least one precious metal is an ion-exchange resin eluate.

In some embodiments, the ion-exchange resin eluate comprises at least one selected from sulfite, bisulfite and metabisulfite, and preferably comprises sulfite. In some embodiments, the ion-exchange resin eluate comprises at least one displacement anion selected from trithionate, chloride, bromide, thiocyanate and nitrate, for example chloride.

In some embodiments, the process further comprises recycling at least a portion of the precious metal-lean aqueous solution to an aqueous eluant for eluting precious metal from a loaded ion-exchange resin comprising precious metal-thiosulfate.

In some embodiments, the precious metal-lean aqueous solution is contacted with one or more further cementation substrates, wherein residual precious metal if present in the precious metal-lean aqueous solution is recovered by deposition on the one or more further cementation substrates in the presence of the soluble reducing agent.

In some embodiments, the cementation substrate is retained in a cementation reactor, and separating the precious metal cementation product from the precious metal-lean aqueous solution comprises flowing the precious metal-lean aqueous solution out of the cementation reactor.

In some embodiments, recovering the precious metal from the precious metal cementation product comprises at least one selected from treating the precious metal cementation product with acid to dissolve the base metal, retorting the precious metal cementation product, calcining the precious metal cementation product and smelting the precious metal cementation product.

In accordance with a second aspect the invention provides a process for recovering precious metal from a precious metal-bearing solid material comprising at least one precious metal selected from gold and silver, the process comprising: leaching the precious metal-bearing solid material with an aqueous lixiviant comprising thiosulfate to produce a leach solution comprising thiosulfate and precious metal; introducing a soluble reducing agent to the leach solution in excess of any oxidants present in the leach solution; contacting the leach solution with a cementation substrate comprising a metallic composition comprising a base metal, wherein the precious metal is reduced in the presence of the reducing agent and the cementation substrate so that reduced precious metal deposits on the cementation substrate to form a precious metal cementation product; and separating the precious metal cementation product from a precious metal-lean leach solution comprising the thiosulfate.

In some embodiments, precious metal-bearing solid material is an ore or concentrate.

In some embodiments, the process further comprises recycling at least a portion of the precious metal-lean leach solution to form at least a portion of the aqueous lixiviant.

In accordance with a third aspect the invention provides a process for recovering precious metal from a loaded absorbent comprising thiosulfate and at least one precious metal selected from gold and silver, the process comprising: eluting the loaded absorbent with an aqueous eluant to produce an eluate comprising thiosulfate and precious metal; introducing a soluble reducing agent to the eluate in excess of any oxidants present in the eluate; contacting the eluate with a cementation substrate comprising a metallic composition comprising a base metal, wherein the precious metal is reduced in the presence of the reducing agent and the cementation substrate so that reduced precious metal deposits on the cementation substrate to form a precious metal cementation product; and separating the precious metal cementation product from a precious metal-lean eluate comprising the thiosulfate.

In some embodiments, the absorbent is a strong base ion-exchange resin.

In some embodiments, the aqueous eluant comprises at least one selected from sulfite, bisulfite and metabisulfite. In some embodiments, the aqueous eluant comprises sulfite.

In some embodiments, the aqueous eluant comprises at least one displacement anion selected from trithionate, chloride, bromide, thiocyanate and nitrate, for example chloride.

In some embodiments, the process further comprises recycling at least a portion of the precious metal-lean eluate to form at least a portion of the aqueous eluant.

Other embodiments of the second and third aspects may generally be as disclosed herein in relation to the first aspect.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

As used herein, the terms “first”, “second”, “third” etc in relation to various features of the disclosed devices are arbitrarily assigned and are merely intended to differentiate between two or more such features that the device may incorporate in various embodiments. The terms do not of themselves indicate any particular orientation or sequence. Moreover, it is to be understood that the presence of a “first” feature does not imply that a “second” feature is present, the presence of a “second” feature does not imply that a “first” feature is present, etc.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 schematically depicts process apparatus for semi-continuously recovering precious metal from a thiosulfate-based hydrometallurgical process solution according to embodiments of the invention.

FIG. 2 schematically depicts process apparatus for recovering precious metal from a precious metal-bearing ore or concentrate according to embodiments of the invention.

FIG. 3 schematically depicts process apparatus for recovering precious metal from a loaded ion-exchange resin according to embodiments of the invention.

FIG. 4 is a graph showing gold recovery as a function of time when a low gold-concentration thiosulfate pregnant leach solution was treated with steel wool and dithionite at various concentrations in Example 2.

FIG. 5 is a graph showing gold and copper solution concentrations as a function of time when a gold- and copper-bearing thiosulfate pregnant leach solution was treated with steel wool and dithionite at various concentrations in Example 3.

FIG. 6 is a graph showing gold recovery as a function of time when a gold- and copper-bearing thiosulfate pregnant leach solution was treated with steel wool and dithionite at various concentrations in Example 3.

FIG. 7 is a graph showing gold recovery as a function of time when a high gold-concentration thiosulfate pregnant leach solution was treated with steel wool and dithionite at various concentrations in Example 4.

FIG. 8 is a graph showing gold solution concentrations as a function of time when thiosulfate pregnant leach solutions, produced by leaching of different gold-bearing ores, were treated with steel wool and dithionite in Example 6.

FIG. 9 is a graph showing gold recovery as a function of time when a gold-bearing thiosulfate pregnant leach solution was treated with different base metal powders in Example 7.

FIG. 10 is a graph showing gold recovery as a function of time when a gold-bearing thiosulfate pregnant leach solution was treated with different base metal powders in combination with dithionite in Example 7.

FIG. 11 is a graph showing gold solution concentrations as a function of time when a gold-bearing thiosulfate pregnant leach solution was treated with different soluble reducing agents in combination with steel wool in Example 8.

FIG. 12 is a graph showing gold recovery as a function of time when a gold-bearing thiosulfate pregnant leach solution was treated with steel wool and/or dithionite in Example 9.

FIG. 13 is a graph showing gold recovery as a function of time when a gold-bearing thiosulfate pregnant leach solution was treated with steel wool and/or dithionite in Example 12.

FIG. 14 is a graph showing gold solution concentrations as a function of time when a gold-bearing thiourea pregnant leach solution was treated with steel wool and/or dithionite in Example 15.

FIG. 15 is a graph showing gold recovery as a function of time when a sulfite-chloride resin eluate containing gold-thiosulfate was treated with steel wool and dithionite at various concentrations in Example 18.

FIG. 16 is a graph showing gold recovery as a function of time when a trithionate resin eluate containing gold-thiosulfate was treated with steel wool and/or dithionite in Example 19.

FIG. 17 is a graph showing gold recovery as a function of time when a gold-bearing thiosulfate pregnant leach solution comprising dithionite was contacted with either mild steel or stainless steel wool in Example 21.

FIG. 18 is a graph showing gold recovery as a function of time when an oxidant-bearing PLS was treated with steel wool and/or dithionite in different stoichiometric ratios relative to oxidant in Example 23.

FIG. 19 is a graph showing gold recovery as a function of time when an oxidant-free PLS was treated with steel wool, with or without dithionite addition, in Example 24.

### DETAILED DESCRIPTION

The present invention relates to a process for recovering precious metal from an aqueous solution comprising thiosulfate and at least one precious metal selected from gold and silver. In the process, a soluble reducing agent is introduced to the aqueous solution in excess of any oxidants present, and the aqueous solution containing the reducing agent is contacted with a cementation substrate in the presence of both the reducing agent and the cementation substrate so that reduced precious metal deposits on the cementation substrate. The cementation substrate comprises a metallic composition comprising a base metal. The resultant precious metal cementation product is then separated from the precious metal-lean aqueous solution, which still contains the thiosulfate, and the precious metal is recovered from the precious metal cementation product.

### Aqueous Solution

The process of the invention recovers precious metal from an aqueous solution comprising gold and/or silver, and thiosulfate. The aqueous solution may be a hydrometallurgical process stream, such as a pregnant leach solution (PLS) or an ion-exchange resin eluate in a mining/minerals processing operation. However, it is also envisaged that the process may be used to recover gold or silver from other thiosulfate-containing aqueous solutions, for example spent gold plating bath solutions.

Thiosulfate has a strong affinity for gold and silver ions in aqueous solution, forming stable anionic complexes such as Au(S₂O₃)₂³⁻ and Ag(S₂O₃)₂³⁻. While the invention is not to be limited by theory, it is expected that at least a portion of the precious metal to be recovered from the aqueous solution will generally be in the form of gold-thiosulfate or silver-thiosulfate complexes. As used herein, a gold- or silver-thiosulfate complex refers to a coordination complex of gold or silver ions containing one or more thiosulfate ligands, including mixed ligand complexes such as thiosulfate-sulfite complexes and the like.

The aqueous solution may, and frequently will, contain free thiosulfate in addition to complexed thiosulfate. The amount of free thiosulfate may depend on the origin of the solution to be processed. Thiosulfate-based lixiviants typically have thiosulfate concentrations of above 0.001 mol/L, or in the range of from 0.02 to 1 mol/L, such as from 0.1 to 0.3 mol/L, and a precious metal-bearing PLS will generally have a free thiosulfate concentration in these ranges. Ion-exchange resin eluates may contain lower free thiosulfate content since thiosulfate is not required to desorb precious metal-thiosulfate complexes from ion-exchange resins. Nevertheless, some free thiosulfate is typically present in eluates, derived from co-adsorbed residual thiosulfate in the loaded resin after the absorption or pre-elution steps and/or desirable reduction reactions of polythionates absorbed on the resin. Ion-exchange resin eluates may have thiosulfate concentrations in the range of from 0.01 to 0.2 mol/L, such as from 0.02 to 0.1 mol/L.

The process is applicable to precious metal-containing solutions having a wide range of gold or silver concentrations. For example, the precious metal may be present in the aqueous solution in an amount of between 0.1 ppm to 10000 ppm. However, the process is considered particularly useful for solutions containing lower concentrations of precious metal, e.g. less than 2000 ppm, or less than 1000 ppm, as is typical for hydrometallurgical process solutions in minerals processing or e-waste processing. High precious metal recoveries, reduction rates and cementation selectivities are generally considered particularly challenging for such solutions. In some embodiments, the precious metal may be present in the aqueous solution in an amount of between 0.5 ppm and 2000 ppm, or between 1 ppm and 500 ppm, such as between 1 ppm and 200 ppm.

In some embodiments, the precious metal to be recovered comprises gold. In some embodiments, the precious metal to be recovered is predominantly, or entirely, gold. Gold is less readily reduced compared to silver, and conventional cementation of gold-bearing solutions representative of typical hydrometallurgical processes has been found to be ineffective. The process of the invention is thus of particular advantage in gold recovery.

Thiosulfate-based hydrometallurgical solutions are typically neutral or alkaline, since thiosulfate decomposes at low pH (e.g. below 4). The aqueous solution may thus have a pH in the range of 5 to 12, such as 6 to 10.

The aqueous solution may comprise one or more oxidants. As used herein, an oxidant refers to any oxidising compound which is more susceptible to reduction than the precious metal species in solution. Such species may have a higher (more positive) reduction potential than the precious-metal thiosulfate complexes present in solution. Thus, any such oxidants dissolved in the aqueous solution must be depleted by reduction or otherwise removed from solution before cementation can be initiated. Common oxidants in precious metal-bearing thiosulfate solutions include copper(II)-complexes (e.g. copper-ammonia), iron(III) complexes (e.g. iron-EDTA or iron-oxalate), nickel or cobalt complexes, and molecular oxygen (O₂).

The aqueous solution may comprise one or more additional solutes typically present in precious metal-bearing thiosulfate solutions. These may include other leached metal species, such as copper-thiosulfate complexes, sulfur species of varying oxidation states such as polythionates (SₓO₆²⁻, where x≥3), sulfite (SO₃²⁻) and sulfate (SO₄²⁻), catalysts such as thiourea, pH control agents, anions such as halides or nitrate for displacing absorbed metal-thiosulfate complexes on ion-exchange resins, and the like.

### Pregnant Leach Solution

In some embodiments, the aqueous solution comprising thiosulfate and precious metal is a PLS. The PLS may have a thiosulfate concentration of above 0.001 mol/L, or in the range of from 0.02 to 1 mol/L, such as from 0.1 to 0.3 mol/L. The PLS may have a precious metal concentration of between 0.5 ppm and 2000 ppm, such as between 1 and 500 ppm, or between 1 and 200 ppm. Excellent gold recoveries have been demonstrated for both synthetic and ore-leached thiosulfate PLS's having gold concentrations of between about 2 ppm and about 160 ppm using the method of the invention.

The PLS may comprise an oxidant. Gold dissolves in oxygen-containing thiosulfate leach solutions according to overall Reaction 1.

4Au⁰+8S₂O₃²⁻+O₂+2H₂O→4Au(S₂O₃)₂³⁻+4OH⁻ (1)

In some embodiments, for example where the aqueous solution is a PLS derived from leaching of pressure-oxidised ores, the oxidant may consist of dissolved oxygen (O₂). However, gold leaching with dissolved oxygen as the direct oxidant is kinetically restricted due to slow reactions of oxygen on the gold metal surface. Accordingly, the PLS may contain a metal oxidant to mediate Reaction 1, for example metal complexes of copper, iron, nickel or cobalt. In such cases, it is understood that the precious metal is directly oxidised by a metal oxidant species, with the resultant reduced metal species then re-oxidised to the oxidic form by dissolved O₂. Common oxidant systems for thiosulfate leaching include copper-ammonia (Cu—NH₃), iron-ethylenediaminetetraacetic acid (Fe-EDTA) and iron-oxalate, with each offering advantages in different applications. The PLS may also comprise an oxidation catalyst, for example thiourea, formamidine disulfide (NH₂—C(═NH)—S—S—C(═NH)—NH₂) or thiosemicarbazide (NH₂—C(═S)—NH—NH₂), to catalyse the gold oxidation half-reaction. The inventors have demonstrated that the process of the invention is compatible with the presence of a variety of common oxidant and catalyst systems present in PLS.

### Resin Eluate

In some embodiments, the aqueous solution comprising thiosulfate and precious metal is an eluate, for example an ion-exchange resin eluate. The ion-exchange resin eluate may have a precious metal concentration of between 5 ppm and 5000 ppm, or between 10 ppm and 2000 ppm, such as between 20 and 500 ppm. At a minimum, thiosulfate corresponding to the eluted precious-metal complexes may be present, but additional thiosulfate may also be present in the eluate, for example derived from free thiosulfate co-adsorbed on the loaded resin after resin loading or pre-elution steps. The thiosulfate concentration may be in the range of from 0.01 to 0.2 mol/L, such as from 0.02 to 0.1 mol/L. The eluate may comprise co-eluted species which were also co-absorbed on the loaded resin, such as other metal anion complexes and polythionates. In addition, the eluate may comprise eluant additives required to desorb and elute the precious metal from the resin. In some embodiments, such additives include sulfite. In these or other embodiments, the eluting additives may include a displacement anion such a trithionate, chloride, bromide, thiocyanate or nitrate.

Excellent gold recoveries have been demonstrated for synthetic resin eluate solutions containing gold-thiosulfate at gold concentrations of about 100 ppm and other eluant components (e.g. sulfite and trithionate or sulfite and chloride) using the method of the invention.

### Reducing Agent

The process of the invention includes a step of introducing a soluble reducing agent to the aqueous solution comprising thiosulfate and precious metal, in excess of any oxidants present in the aqueous solution. As used herein, a soluble reducing agent is one which is soluble in the aqueous solution containing the thiosulfate and precious metal.

Without wishing to be bound by any theory, it is proposed that the soluble reducing agent plays a number of roles in the precious metal recovery process. Firstly, it reduces any residual oxidant species in solution, in particular those which have a higher (more positive) reduction potential than the precious-metal thiosulfate complexes. Such species may include dissolved oxygen and metal oxidants present in PLS to mediate the oxidative gold leaching reaction. The reduction of these species ensures that a suitable reducing environment is provided to facilitate reductive cementation of precious metal on the cementation substrate. Moreover, passivation of the cementation substrate may be avoided or mitigated because the base metal is not required to perform the reduction of the oxidant species. In the case of an iron substrate, for example, passivation by iron hydroxide may be avoided. The metallic surface of the cementation substrate thus remains available to receive and reduce precious metal.

Secondly, the soluble reducing agent and base metal of the cementation substrate may synergistically cooperate to reduce the precious metal species present in solution and deposit precious metal on the cementation substrate. In the absence of a base metal cementation substrate, the soluble reducing agent may still be capable of reducing the precious metal in solution. However, a significant issue with this approach is that a very fine precious metal precipitate is formed, which is difficult to separate from the barren solution. Surprisingly, it has been found that the precious metal deposits preferentially on the cementation substrate even when it would be expected, for example by comparing the reduction potentials of the soluble reducing agent and the cementation base metal, that the soluble reducing agent should be the primary reagent involved in the reduction reaction. It is proposed that the gold-thiosulfate complex is preferentially reduced and the reduced gold is deposited on existing nucleation sites provided by the cementation substrate rather than forming new nucleation sites. Moreover, it has been found that the reduction kinetics and percentage recovery are significantly improved when the soluble reducing agent and cementation substrate are used in tandem.

A wide range of soluble reducing reagents are considered suitable for the process of the invention, subject to the following considerations. The soluble reducing agent should be capable of reducing residual oxidants in the aqueous solution and thus establishing a reducing environment conducive to cementation. Common oxidants in PLS include O₂, Cu—NH₃ and Fe-EDTA, which are expected to reduce according to Half-Reactions 2, 3 and 4 having standard reduction potentials (E⁰) of +0.40V, +0.22V and +0.13V respectively.

O₂+2H₂O+4e⁻→4OH⁻ (2)

Cu(NH₃)₄²⁺+3S₂O₃²⁻+e⁻→Cu(S₂O₃)₃⁵⁻+4NH₃

Fe³⁺-EDTA+e⁻→Fe²⁺-EDTA (4)

Accordingly, the soluble reducing agent in at least some embodiments has a reduction potential in the aqueous solution below the reduction potential of any oxidant species that are present.

Moreover, without wishing to be bound by any theory, it is believed that certain soluble reducing agents participate in redox reactions with at least a portion of the precious metal species in solution. Gold-thiosulfate complexes present in PLS are expected to reduce according to Half-Reaction 5, which has a standard reduction potential (E⁰) of +0.15V. The soluble reducing agent may thus have a reduction potential in solution which is sufficiently low to induce this redox reaction to occur.

Au(S₂O₃)₂³⁻+e⁻→Au⁰+2S₂O₃²⁻ (5)

It is also preferred that the soluble reducing agent does not participate in undesirable redox reactions, in particular reduction reactions of free thiosulfate. Where the aqueous solution includes a metal oxidant which transitions between two oxidation states during leaching (e.g. Cu²⁺/Cu⁺ or Fe³⁺/Fe²⁺ species), over-reduction reactions leading to loss of the metal oxidant additive from solution are also to be avoided, particularly where the aqueous solution is to be recycled to a leaching step. For this reason, excessively strong reducing agents may be avoided.

In some embodiments, the soluble reducing agent has a standard reduction potential (E⁰) below (more negative than) about +0.4V, or below about +0.2V, or below about +0.15V. In some embodiments, the soluble reducing agent has a standard reduction potential (E⁰) in the range of about −1.7V to about +0.4V, or in the range of about −1.7V to about +0.2V, or in the range of about −1.3V to about +0.15V.

While standard reduction potentials may be useful as a guide in selecting a suitable reducing agent, it will be appreciated that such parameters are based on thermodynamics alone and ignore the impact of reaction kinetics and implementation-specific factors such as pH, interfering reactions etc. With the benefit of this disclosure, the skilled person can identify suitable soluble reducing agents with no more than routine trial and error.

Non-limiting examples of suitable soluble reducing agents are ascorbic acid (E⁰=0.06V), dithionite (S₂O₄²⁻, E⁰=−1.12V), borohydride (BH₄⁻, E⁰=−1.24V), hydrazine (N₂H₄, E⁰=−1.16V), hydroxylamine (H₂NOH, E⁰=−1.05V), and combinations thereof.

In some embodiments, the soluble reducing agent is dithionite (S₂O₄²⁻), for example introduced as sodium dithionite (Na₂S₂O₄). Dithionite (also known as hydrosulfite) is considered a particularly suitable reducing agent because of its compatibility with thiosulfate-based solutions in hydrometallurgical processes. When used as a reducing agent, dithionite is oxidised according to Half-Reaction 6 to produce sulfite (SO₃²⁻).

S₂O₄²⁻+4OH⁻→2SO₃²⁻+2H₂O+2e⁻ (6)

Sulfite is generally well-tolerated in thiosulfate-based hydrometallurgical solutions, and may in fact be a beneficial additive. In leaching solutions or resin eluates, sulfite can react with tetrathionates and higher polythionates, which are degradation products of thiosulfate, converting them back to thiosulfate. Such reactions are thought to occur according to Reaction 7.

SₓO₆²⁻+SO₃²⁻→2S₂O₃²⁻+S₍ₓ₋₁₎O₆²⁻ (x=4 or greater) (7).

In the case of ion-exchange resin eluates, sulfite can also assist with desorption of gold-thiosulfate complexes from the loaded resin, apparently by forming weakly bound mixed gold-thiosulfate-sulfite complexes. Sulfite may be added as an intentional component of the eluant for this very reason, and its accumulation in the eluant caused by recycling the barren eluate can thus readily be accommodated.

The inventors have demonstrated that dithionite is capable of synergistically cooperating with base metal substrates to recover gold from solution, with fast kinetics and higher recoveries, while not significantly consuming the thiosulfate or over-reducing metal oxidants in solution.

The soluble reducing agent, for example dithionite, is introduced to the aqueous solution in an amount sufficient to reduce the oxidant species in solution and facilitate reduction of the precious metal. Where air cannot be rigorously excluded, sufficient excess reducing agent should be present to scavenge oxygen which enters the solution. The amount of soluble reducing agent needed to avoid underdosing (i.e. the amount needed to maintain a slight excess in solution) can be determined by measuring the oxidation-reduction potential (Eh) of the dosed solutions, for example using a platinum ORP (Oxidation-Reduction-Potential) electrode. It is preferred that a safe excess of soluble reducing agent is present, since depletion of the reducing agent may result in re-dissolution of the deposited precious metal from the cementation product. However, excessive amounts of soluble reducing agent are also to be avoided due to the risk of homogeneous reduction of precious metal to fine particulates. Excess addition of soluble reducing agent can be monitored and thus mitigated by turbidity measurements of the resultant solution, which can detect the formation of fine precipitates. In some embodiments, the soluble reducing agent is introduced at a concentration of between 0.1 mmol/L and 50 mmol/L, for example between 1 mmol/L and 20 mmol/L, or between 1 mmol/L and 10 mmol/L.

For a PLS, the metal oxidant may be the most abundant species in solution requiring reduction, and the amount of soluble reducing agent can be selected based on the known amount of this component. For example, where the PLS contains a metal oxidant concentration of 3 mmol/L, and the reducing agent is dithionite, a dithionite concentration of 2-3 mmol/L has been found sufficient to reduce the metal oxidant, scavenge dissolved oxygen and facilitate precious metal deposition (considering that the stoichiometric reaction ratio of metal oxidant to dithionite is 2:1). Fora resin eluate, the concentration of oxidants in solution may be considerably lower than for a PLS, so that correspondingly lower amounts of the soluble reducing agent can be used.

### Cementation

The process of the invention includes a step of contacting the aqueous solution with a cementation substrate. The precious metal is reduced in the presence of the reducing agent and the cementation substrate so that the reduced precious metal deposits on the cementation substrate. A precious metal cementation product, comprising metallic precious metal adhered to the cementation substrate, is thus formed.

The initial contact between the aqueous solution and the cementation substrate may occur before, simultaneously with or after the soluble reducing agent is introduced to the solution. Preferably, it occurs immediately after or at about the same time as the soluble reducing agent is introduced, so that the gold reduction process is driven by the synergistic combination of both materials. Premature introduction of the soluble reducing agent may undesirably induce precipitation of fine precious metal particles from the solution. Thus, in some embodiments, the aqueous solution is contacted with the cementation substrate before depleting the oxidants with the soluble reducing agent.

The cementation substrate comprises a metallic composition comprising a base metal. As used herein, a base metal refers to a base metal element, and a metallic composition refers to a composition in which the metal elements in the bulk of the composition are substantially reduced, i.e. in the metal(0) oxidation state. The metallic composition may comprise a single base metal or alloys of a base metal with one or more other elements including base metals, other metals and non-metals.

As already discussed, the soluble reducing agent and base metal may synergistically cooperate to reduce the precious metal species present in solution and deposit precious metal on the cementation substrate. Without wishing to be limited by theory, it is proposed that one role of the base metal substrate in this process is to provide nucleation sites to facilitate the reduction of precious metal-thiosulfate complexes and deposition as metallic precious metal. The cementation process may involve some redox displacement reactions between base metal and precious metal to facilitate the deposition, although in at least some embodiments it is expected that the oxidation and dissolution of base metal will be more limited than a conventional cementation process, where the base metal substrate is the primary reductant. Accordingly, the amount of base metal entering the solution and/or passivating the substrate surface due to oxidation reactions may be relatively lower.

A wide range of base metals are effective, at least to a degree, in the process of the invention, and the invention in its broadest form is not considered to be limited to specific base metal elements. The redox reaction of base metals between their metallic and oxidised forms generally has a lower (more negative) reduction potential than the reduction reaction of the precious metal species in solution. In the case where the solution contains Au(S₂O₃)₂³⁻, which is expected to be present in gold-bearing PLS, a wide range of base metal elements have a lower standard reduction potential than Half-Reaction 5 and may thus be used.

In some embodiments, the cementation substrate comprises at least one base metal selected from iron, copper, aluminium, nickel and zinc. Copper provides fast cementation kinetics, and may be desirable in some scenarios for this reason. However, copper may be less favoured in other embodiments because of its propensity to consume thiosulfate, both by complex formation, e.g. via Reaction 8, and by inducing decomposition of the thiosulfate. Moreover, thiosulfate complexation via Reaction 8 increases the pH of the solution, which can destabilise components of the solution including some metal oxidants in PLS (e.g. Fe-EDTA). It is noted that the use of a soluble reducing agent, such as dithionite, in combination with copper significantly ameliorates these issues compared to the case where copper metal is used alone. This may allow copper to be used as the cementation substrate in cases where the thiosulfate and/or oxidant consumption would otherwise have been unacceptable.

4Cu⁰+O₂+12S₂O₃²⁻+2H₂O→4Cu(S₂O₃)₃⁵⁻+4OH⁻ (8)

Zinc may also be less preferred in certain embodiments, both because of its relatively slower cementation kinetics and because the resultant zinc ions can destabilise metal oxidant in PLS, e.g. by competing for EDTA when using Fe-EDTA.

In some embodiments, the base metal may be selected from iron, aluminium and nickel. Each of these base metals has been found compatible with thiosulfate-based solutions and to provide good cementation kinetics in dithionite-mediated cementation.

In some embodiments, the metallic composition comprises iron, for example in the form of iron metal or steel. Iron-based cementation substrates have a number of advantages in the invention, including fast cementation kinetics and low cost. Moreover, the introduction of soluble iron species into thiosulfate-based solutions is generally well tolerated in hydrometallurgical processes, particularly when iron oxidant complexes are used in the leaching solution. The use of iron thus avoids the introduction of extraneous metal species into the system.

In neutral or alkaline solutions (e.g. pH greater than about 5.5), iron participates in redox reactions according to Half-Reaction 9. Iron hydroxide is thus a by-product when iron metal reduces oxidant species, e.g. according to Half-Reactions 2-4, or precious metal species, e.g. according to Reaction 10.

Fe⁰+2OH⁻→Fe(OH)₂+2e⁻ (9)

Fe⁰+2Au(S₂O₃)₂³⁻+2OH⁻→2Au⁰+Fe(OH)₂+4S₂O₃²⁻ (10)

Passivation of the cementation substrate by iron hydroxide may be one contributor to the relatively ineffective recovery of gold obtained when using iron metal alone. By contrast, the combination of iron as cementation substrate and a soluble reducing agent, such as dithionite, to perform a major portion of the required reduction reactions has been found highly effective in achieving excellent gold recoveries at good reaction rates. Any iron hydroxide which is nevertheless formed in the process appears to have a negligible effect on precious metal recovery.

The cementation process may be conducted under inertised conditions, for example under N₂ atmosphere, to avoid or limit consumption of the soluble reducing agent by O₂ and to maintain a suitable reducing environment for the cementation reactions to occur.

The base metal cementation substrate preferably has a high surface to volume ratio to facilitate rapid deposition kinetics and to ensure that the resultant cementation product has an acceptable mass ratio of precious metal to base metal. The cementation substrate may thus be in the form of powder, e.g. pulverised iron metal, or in the form of a plate, rod, wire or wool, e.g. iron or steel mesh or wool. The use of a fine wool or mesh may be particularly advantageous because the cementation substrate can be distributed through the solution volume during the cementation process and conveniently separated from the lean solution once precious metal has deposited. For example, as will be disclosed in greater detail hereafter, the aqueous solution can be flowed through one or more cementation reactors containing iron or steel wool.

The base metal cementation substrate may be used in an amount sufficient to recover the precious metal. Higher amounts of cementation substrate will generally result in faster deposition kinetics, although the resultant precious metal cementation product may then have a lower mass fraction of precious metal. It will be appreciated that the amount of cementation substrate may be selected to achieve a reasonable balance between these two imperatives. In some embodiments, noting the possibility of continuously flowing the aqueous solution over the cementation substrate, the base metal cementation substrate may be used in an amount of 0.001 to 10 g/L of aqueous solution, for example 0.01 to 1 g/L.

The aqueous solution comprising the reducing agent may be contacted with the cementation substrate for a suitable contact time, or residence time in the case of a continuous process. The contact time may be selected to provide a high recovery of precious metal from the aqueous solution. For example, the contact time may be in the range of 1 minute to 24 hours, such as in the range of 10 minutes to 10 hours. A contact time of 1 hour has been found sufficient for excellent gold recoveries from a variety of gold-bearing thiosulfate solutions when using dithionite and iron.

The process of the invention may reduce and remove a high fraction of precious metal from the aqueous solution, either in a single cementation reactor or via a series of cementation reactors as will be explained in further detail hereafter. In some embodiments, at least 80%, or at least 90%, or at least 95% of the precious metal is removed from the aqueous solution. While a high recovery fraction is generally desirable, it is noted that quantitative recovery may not be required in all cases since the precious metal-lean aqueous solution may be recycled back to leaching or elution steps. Residual precious metal in solution is thus not lost to the process.

It is desirable that a high fraction of the precious metal removed from the aqueous solution is recovered in the cementation product, as opposed for example to precipitation as fine precious metal particles. In some embodiments, at least 60%, or at least 70%, or at least 80%, or at least 90%, of the precious metal reduced in the presence of the reducing agent and the cementation substrate is deposited on the cementation substrate and is thus present in the precious metal cementation product. It has surprisingly been found that over 90% of gold reduced from a gold-bearing thiosulfate PLS can be recovered in a gold-iron cementation product when using a combination of steel wool as the substrate and dithionite as the soluble reducing agent, despite the demonstrated capability of dithionite to precipitate metallic gold from solutions of gold-thiosulfate complexes.

### Separation and Precious Metal Recovery

The process of the invention includes a step of separating the precious metal cementation product from the precious metal-lean aqueous solution remaining after the cementation process.

As used herein, a precious metal-lean aqueous solution refers to the aqueous solution after at least a portion of the precious metal has been recovered therefrom. While the precious metal content is thus reduced compared to the initial aqueous solution, some residual precious metal content may still be present. The precious metal-lean aqueous solution comprises at least a portion of, and typically substantially all of the thiosulfate that was present in the initial aqueous solution. Other soluble components may include unreacted soluble reducing agent, the redox products of the reducing agent (e.g. sulfite in the case where dithionite is used), reduced forms of the oxidant metal complexes, catalysts, soluble elution anions such as halides or nitrate for displacing absorbed metal-thiosulfate complexes on ion-exchange resins, and the like. Advantageously, the precious metal-lean aqueous solution containing these solutes may be recycled in an overall hydrometallurgical process, for example to a lixiviant or eluant.

Separation of the precious metal cementation product from the lean solution is typically a simple matter because the cementation substrate can be configured to facilitate this. Separation methods used in conventional cementation technology can be employed, for example filtration when metal particles, filings, powders or dust are used.

In some embodiments, the aqueous solution containing precious metal, thiosulfate and introduced soluble reducing agent is flowed through one or more cementation reactors containing a cementation substrate, for example in the form of a mesh or wool arranged throughout the internal volume. This can be done in batch or continuous mode. In such embodiments, the separation step simply involves flowing the precious metal-lean aqueous solution out of the reactor after a suitable contact or residence time, leaving the reduced precious metal content on the mesh or wool cementation product. Once a suitably high loading of precious metal is achieved, or the cementation substrate is no longer capable of receiving precious metal deposits (e.g. due to passivation or high coverage by precious metal), the reactor can be taken off-line and the precious metal cementation product physically removed. A fresh cementation substrate can then be introduced and the reactor is placed back on-line.

The process of the invention may include a step of recovering precious metal from the precious metal cementation product. The recovery step may remove the base metal and other impurities to provide a higher purity precious metal product. Again, conventional techniques can be used for this step, including retorting the precious metal cementation product, calcining to convert the base metal to metal oxides or treating the precious metal cementation product with acid to dissolve the base metal. The precious metal can then be refined by smelting to produce a high purity product.

In one set of embodiments, the step of recovering gold from the precious metal cementation product comprises producing a crude bullion (e.g. 90-99% Au) which is then suitable for further processing in a refinery. Depending on the metals present in the precious metal cementation product, this may involve one or more pre-treatment steps such as (1) distillation/retorting to remove mercury, (2) acid parting to separate Ag from Au (e.g. when Ag content is >66%), for example by dissolving Ag in nitric acid, (3) volatilisation to remove lead, (4) copper removal by fusion with lead, by electrolysis or by smelting to produce a copper matte, (5) acid leaching to remove acid soluble impurities such as Fe, Zn, etc. After the above pre-treatment(s), the product undergoes roasting (calcining), followed by smelting to produce the crude gold bullion.

### Process Design

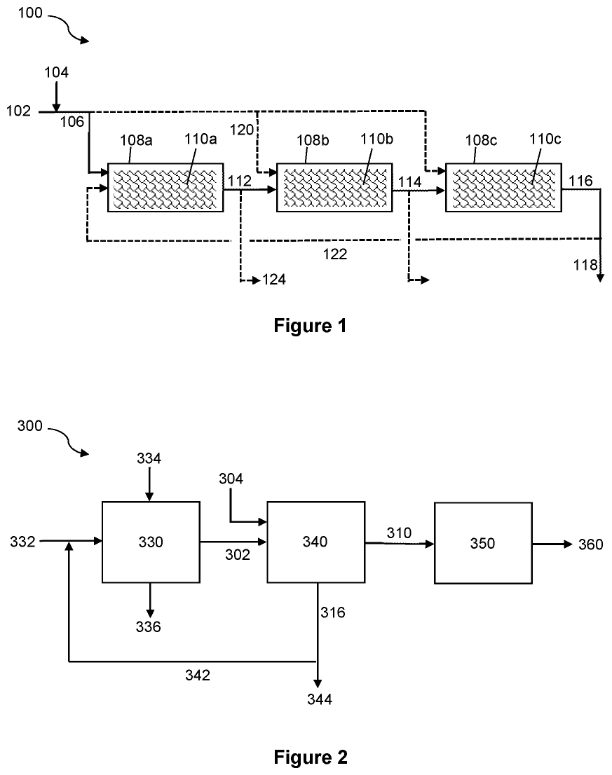

An embodiment of the invention will now be described with reference to FIG. 1, which depicts apparatus 100 for semi-continuously recovering precious metal from a hydrometallurgical process solution. Aqueous solution 102, which comprises thiosulfate and gold, may be a PLS or ion-exchange resin eluate as described herein. In some embodiments, aqueous solution 102 is a PLS comprising thiosulfate in a concentration of 0.02 to 1 mol/L, dissolved gold in a concentration of 1 ppm to 200 ppm, optionally a metal oxidant (e.g. Fe-EDTA or Cu—NH₃), optionally a catalyst (e.g. thiourea) and typically dissolved oxygen. Sodium dithionite solution 104 is mixed with aqueous solution 102 in excess of the amount needed to reduce the dissolved oxidant species, and the mixed solution 106 is immediately fed into first cementation reactor 108a where it contacts first steel wool cementation substrate 110a. Reactor 108a may be enclosed and/or maintained under an inert atmosphere, e.g. N₂, to limit the ingress of oxygen. Cementation substrate 110a may be arranged so that the steel wool is distributed throughout the interior liquid volume, and the solution may optionally be agitated or recirculated though reactor 108a to provide good mixing and contact with the cementation substrate. Gold in the solution is thus reduced and deposits on the cementation substrate as disclosed herein.

After a suitable residence time in reactor 108a, the gold-lean aqueous solution 112 is flowed successively through second and third cementation reactors 108b and 108b, where further gold deposition may occur on second and third steel wool cementation substrates 110b and 110c respectively. Optionally, further amounts of reducing agent may be added separately to these reactors (not shown) to maintain a reducing environment. Little gold may initially be recovered in the second and third reactors if the recovery is high in first reactor 108a. However, as cementation substrate 110a is gradually covered with gold deposits and/or passivated, the recovery efficiency in reactor 108a may decrease so that higher amounts of unreduced gold are transferred to the downstream cementation reactors for recovery. The ultimate gold-lean aqueous solution 116 flowing out of cementation reactor 108c via line 118 has a very low residual gold content, and may optionally be recycled to a thiosulfate leaching or elution process step.

Once the rate of gold deposition in first reactor 108a drops below a minimum desirable threshold, or a desirable amount of gold has deposited on cementation substrate 110a, first reactor 108a may be taken offline and solution 106 is redirected via line 120 for initial recovery in second reactor 108b. Reactor 108b thus becomes the primary gold recovery reactor, with reactor 108c recovering any gold that breaks through in gold-lean aqueous solution 114. Meanwhile, the precious metal cementation product comprising steel wool substrate 110a with gold deposits cemented thereon is removed from reactor 108a and replaced with a fresh cementation substrate 110a. Reactor 108a is then brought back online, but this time as the final cementation reactor in series. Thus, gold-lean aqueous solution 116 is redirected via line 122 to reactor 108a, and gold-lean aqueous solution 112 is taken as the final product of the recovery process, via line 124.

In this way, the process cycles between the three cementation reactors, with each in turn becoming the primary gold recovery reactor. The resultant precious metal cementation products taken in turn from each reactor are processed to recover the gold content by conventional means, for example by dissolving the steel away in a strong mineral acid or by calcining in air, followed by smelting to produce gold ore.

Over time, a small proportion of the gold may accumulate in reactors 108a, 108b and 108c, for example as precipitated gold particles or cementation products on detached scrap pieces of steel wool. This gold may be recovered manually during shutdowns, or periodically re-dissolved under oxidising conditions into a thiosulfate-based leaching solution passed through the reactors.

While apparatus 100 is shown with three cementation reactors in series, it will be appreciated that fewer or more reactors can similarly be utilised, and that combinations of reactors in series and parallel can be used. Moreover, the process can be operated semi-continuously, as shown, or in batch mode. For example, in a semi-batch alternative to the configuration depicted in FIG. 1, an inventory of mixed solution 106 is recirculated repeatedly through a single cementation reactor 108a until the dissolved gold content drops below a target value due to gold deposition on cementation substrate 110a. The resultant gold-lean aqueous solution 112 is then discharged for further processing, e.g. recycling to a thiosulfate leaching or elution process step, and fresh mixed solution 106 is added to reactor 108a. This cycle is repeated until the rate of cementation drops below a minimum desirable threshold or a desirable amount of gold has deposited on cementation substrate 110a, at which point reactor 108a may be taken offline for gold recovery.

Process for Recovering Precious Metal from a Solid Material

The present invention also relates to a process for recovering precious metal from a precious metal-bearing solid material comprising gold and/or silver. The process involves leaching the precious metal-bearing solid material with an aqueous lixiviant comprising thiosulfate to produce a leach solution comprising thiosulfate and precious metal. Precious metal is then recovered from the leach solution by a method as already disclosed herein. The invention thus allows gold recovery from pregnant leach solutions without the need for ion-exchange technology.

The precious metal-bearing solid material may be any solid material susceptible to gold and/or silver leaching with a thiosulfate-based lixiviant. In some embodiments, it is an ore or a concentrate, for example as produced in a mining operation. Alternatively, it may be a secondary source such as an e-waste product.

In some embodiments, the metal-bearing solid material may comprise copper which is co-leached into the leach solution with the precious metal. The copper may then be co-deposited on the cementation product together with the precious metal by the methods disclosed herein, releasing the thiosulfate into the precious metal-lean aqueous solution for recycling. In this manner, copper values can be recovered in the leaching process in addition to the precious metal.

The leaching step may be any process that provides contact between the precious metal-bearing solid material and lixiviant, such as in-situ, dump, heap, vat or tank leach processes.

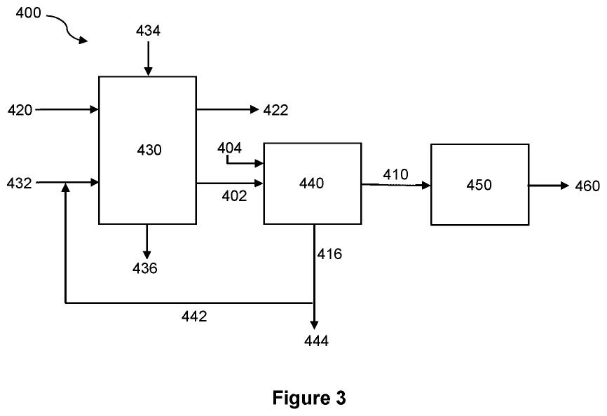

An embodiment of the invention will now be described with reference to FIG. 2, which depicts apparatus 300 for recovering precious metal from a precious metal-bearing ore or concentrate. In leaching unit 330, aqueous lixiviant 332 comprising thiosulfate is used to leach a comminuted gold-bearing ore or concentrate 334. In some embodiments, aqueous lixiviant 332 comprises thiosulfate in a concentration of 0.02 to 1 mol/L, a metal oxidant complex (e.g. Fe-EDTA or Cu—NH₃), dissolved oxygen and optionally a catalyst such as thiourea. More generally, however, the leaching step may be conducted via any of a range of known methods for extracting precious metals using thiosulfate based lixiviants. The process of the invention may thus adopt conventional aspects of such technology, including pre-treatments of the ore, leaching additives, leaching conditions (e.g. temperature and residence time), process equipment and process design (e.g. single stage vs multistage leaching). The leaching step results in the formation of a solid leach residue 336 and a pregnant leach solution (PLS) 302. PLS 302 may, for example, comprise gold in a concentration of 1 ppm to 500 ppm. In some embodiments, PLS 302 also comprises other metals leached from ore or concentrate 334, for example silver and/or copper. PLS 302 may comprise thiosulfate degradation products such as polythionates.

PLS 302 is then subjected to a gold recovery process in cementation unit 340, using a soluble reducing agent 304 to induce deposition of gold on a cementation substrate according to a method as generally disclosed herein. In some embodiments, cementation unit 340 comprises apparatus 100 and operates according to the exemplary embodiment described herein with reference to FIG. 1. The products of cementation unit 340 are gold-lean leach solution 316 and gold-cementation product 310.

Solution 316 may comprise thiosulfate and thiosulfate degradation products (e.g. polythionates), redox products of the soluble reducing agent (e.g. sulfite when dithionite is used), soluble leach additives (or their reduced counterparts) which were present in lixiviant 332, residual gold and other leached metals which were not co-deposited with the gold in the cementation product. Gold-lean leach solution 316 can be recycled via stream 342 to form all or part of aqueous lixiviant 332, optionally purging a portion via purge stream 344 to maintain acceptable levels of dissolved metals and various by-products in the lixiviant. Metal oxidant complexes present in PLS 302 (e.g. Cu—NH₃ or Fe-EDTA) will be converted to their corresponding reduced form (e.g. Cu(S₂O₃)₃⁵⁻ or Fe²⁺-EDTA) in cementation unit 340, but these can readily be re-oxidised by introducing oxygen in the leaching process step, or topped-up as required. A lixiviant regeneration step may optionally be used to treat the gold-lean leach solution 316 before recycle to form all or part of aqueous lixiviant 332. This could include for example conversion of tetrathionate to thiosulfate and trithionate using sulfite or conversion of trithionate to thiosulfate using sulfide.

When dithionite is used as the soluble reducing agent, the sulfite by-product can advantageously convert tetrathionates and higher polythionates, which are degradation products of thiosulfate typically formed in leaching, to thiosulfate. By eliminating or reducing tetrathionates and higher polythionates in the recycled leach solution, the stability of gold thiosulfate may be enhanced during the leaching process. Tetrathionates and higher polythionates can cause gold losses via precipitation with other metals (e.g. silver or copper) and preg-robbing onto sulfide minerals.

A large portion of the gold ores worldwide contain copper and copper can dissolve during the thiosulfate leaching process to form copper thiosulfate complexes (e.g. Cu(S₂O₃)₃⁵⁻); dissolution of copper consumes large quantities of thiosulfate and reduces the free thiosulfate concentration available for gold leaching. When iron is used as the cementation substrate, copper can be recovered simultaneously with gold during which the thiosulfate associated with copper is released and made available for gold leaching. When Fe-EDTA is used as the oxidant, the use of iron as the cementation substrate may offer a means of introducing iron into the leach solution to compensate any loss of iron in the leaching process.

Cementation product 310 comprising the recovered gold is removed from cementation unit 340 and can optionally be sent to recovery unit 350. In this unit, the gold can be recovered as high purity gold product 360 by conventional means, for example by acid dissolution of the base metal substrate or calcination in air, followed by smelting.

Process for Recovering Precious Metal from a Loaded Absorbent

The present invention also relates to a process for recovering precious metal from a loaded absorbent comprising thiosulfate and at least one precious metal selected from gold and silver. The process involves eluting the loaded absorbent with an aqueous eluant to produce an eluate comprising thiosulfate and the precious metal. Precious metal is then recovered from the eluate by a method as already disclosed herein. The invention thus allows gold recovery from resin eluates without the need for electrowinning.

The absorbent may in principle be any absorbent suitable for sequential absorption and elution of precious metal from thiosulfate-based solutions, in particular thiosulfate PLS. In some embodiments, the absorbent is a basic ion-exchange resin, for example a strong base ion-exchange resin. The resin absorbent may be loaded with precious metal extracted from a gold- and/or silver-bearing solid material with thiosulfate lixiviants, for example in a resin-in-pulp, resin-in-leach or resin-in-column process.

Strong base ion-exchange resins are not highly selective for precious metal-thiosulfate complexes, so that other species in thiosulfate PLS such as copper-thiosulfate complexes and polythionates will compete for absorption capacity. Thus, in some embodiments, the process involves a step of pre-eluting the loaded absorbent to remove at least a portion of other absorbed species. Suitable pre-eluants for this purpose may include ammonium thiosulfate solutions. The precious metal-thiosulfate species may be preferentially retained on the loaded absorbent after the pre-elution step. Some residual free thiosulfate may also be present in the resin, for example when the pre-eluant contains thiosulfate.

A variety of aqueous eluants may be used to elute the precious metal from the loaded absorbent. In some embodiments, the eluant comprises sulfite, which is believed to assist with gold desorption by forming weakly bound mixed thiosulfate-sulfite gold complexes. Bisulfite (HSO₃⁻) and metabisulfite (S₂O₅²⁻) are alternative additives for this purpose. In some embodiments, the eluant comprises a displacement anion, such as trithionate, chloride, bromide, thiocyanate or nitrate. When present in high concentrations, such anions displace precious metal-thiosulfate complexes from the anion-exchange sites on the loaded resin, facilitating their elution. In some embodiments, the eluant comprises both sulfite and a displacement anion, which operate in tandem to desorb and replace the anionic precious metal complexes on the resin absorption sites.

An embodiment of the invention will now be described with reference to FIG. 3, which depicts apparatus 400 for recovering precious metal from a loaded absorbent comprising precious metal and thiosulfate, in particular an absorbent loaded with precious metal-thiosulfate complexes.

Elution unit 430 contains a strong base ion-exchange resin, for example in a column through which eluant can be passed. The ion-exchange resin may be pre-loaded with gold-thiosulfate PLS in a separate absorption process unit before transfer into elution unit 430. Alternatively, the ion-exchange resin is present in the same column of unit 430 through successive absorption and desorption (elution) cycles. In either case, the loaded resin may optionally be subjected to a pre-elution step by passing pre-eluant 420, e.g. an ammonium thiosulfate solution, through the column. One or more co-adsorbed species, e.g. copper-thiosulfate complexes and polythionates, are thus eluted into pre-eluate 422, while most or all of the gold-thiosulfate complexes remain adsorbed on the resin after the pre-elution.

The resin absorbent is then eluted with aqueous eluant 432 designed to desorb gold-thiosulfate complexes and thus produce eluate 402 containing thiosulfate and gold. Gold may be present in the eluate in a concentration of 20 ppm to 500 ppm. In such embodiments, eluate 402 contains gold-thiosulfate complexes, free thiosulfate, polythionates (including trithionate), sulfite and an anion selected from trithionate, chloride, bromide, thiocyanate and nitrate. More generally, however, the elution step may be conducted via any of a range of known methods for eluting precious metal-thiosulfate from resin absorbents. The process of the invention may thus adopt prior-reported aspects of such technology, including suitable eluant compositions, elution conditions (e.g. temperature and space velocities) and process equipment. Once the gold content is sufficiently eluted, unloaded resin 436 may optionally be removed from elution unit 430 and sent back to a separate absorption unit. In some embodiments, the resin undergoes a regeneration step, such as sulfide treatment to convert trithionate to thiosulfate, before being sent back to the separate adsorption unit.

Eluate 402 is then subjected to a gold recovery process in cementation unit 440, using a soluble reducing agent 404 to induce deposition of gold on a cementation substrate according to a method as generally disclosed herein. In some embodiments, cementation unit 440 comprises apparatus 100 and operates according to the exemplary embodiment described herein with reference to FIG. 1. The products of cementation unit 440 are gold-lean eluate solution 416 and gold-cementation product 410.

Gold-lean eluate solution 416 can be recycled via stream 442 to form all or part of aqueous eluant 432, optionally purging a portion via purge stream 444. The use of dithionite as the soluble reducing agent is particularly compatible with processes using sulfite-containing eluants, since recycling of solution 416 containing sulfite by-product can supply or supplement the required sulfite component of eluant 432. Cementation product 410 can be removed from cementation unit 440 and optionally sent to recovery unit 450 for recovery of the gold content by conventional means.

### EXAMPLES

The present invention is described with reference to the following examples. It is to be understood that the examples are illustrative of and not limiting to the invention described herein.

### Example 1

A synthetic gold-bearing PLS (hereafter PLS-1) was prepared to simulate gold recovery from an Fe-EDTA thiosulfate leaching system. PLS-1 contained 0.1 mol/L sodium thiosulfate, 3 mmol/L ferric sodium EDTA, thiourea and 2.5 mg/L gold added as sodium gold thiosulfate, and had a pH of between 6 and 7. Glass bottles (nominal 100 mL volume) were filled with 130 mL of the PLS-1 solution so that minimal headspace remained in the bottle. Iron metal powder (particle size 0.149 mm or 100 mesh), or sodium dithionite, or both, was added to the bottles as shown in Table 1, and the bottles were capped and rolled. Samples (4 mL) were withdrawn and filtered after 10, 30, 60 minutes for gold analysis by ICP.

TABLE 1

| | | | | | Dithionite (10 | |
|---|---|---|---|---|---|---|
| | Fe powder | | Dithionite | | mmol/L) + Fe powder | |
| | (12 g/L) | | (60 mmol/L) | | (1.5 g/L) | |
| | Au | Recovery | Au | Recovery | Au | Recovery |
| Time | (mg/L) | (%) | (mg/L) | (%) | (mg/L) | (%) |
| 0 | 2.49 | 0.0 | 2.49 | 0.0 | 2.49 | 0 |
| 10 | 2.40 | 3.6 | 2.30 | 7.6 | 1.60 | 35.7 |
| 30 | 2.37 | 4.8 | 1.66 | 33.3 | 0.29 | 88.3 |
| 60 | 2.3 | 7.6 | 0.39 | 84.3 | 0.08 | 96.6 |

As seen in Table 1, the iron powder by itself was ineffective in recovering gold. It is proposed that the iron metal initially reduces Fe³⁺-EDTA to Fe²⁺-EDTA via Reaction 11 before gold thiosulfate anions can be reduced to metallic gold via Reaction and that the iron hydroxide by-product from both reactions coats and thus passivates the iron surface.

2Fe³⁺-EDTA+Fe⁰+2OH⁻→2Fe²⁺-EDTA+Fe(OH)₂ (11)

Dithionite, by itself, was only moderately effective to reduce gold. A recovery of 84% was obtained in 1 hour when using a high dithionite concentration. It is believed that this gold reduction takes place via Reaction 12. Moreover, the fine gold precipitate formed (particle size: d50=8.3 μm) is difficult to recover by filtration.

2Au(S₂O₃)₂³⁻+S₂O₄²⁻+4OH⁻→2Au⁰+2SO₃²⁻+4S₂O₃²⁻+2H₂O (12)

Surprisingly, the combination of iron metal and dithionite was highly effective in recovering gold. Thus, as seen in Table 1, 97% gold recovery was obtained in 1 hour despite using much lower absolute amounts of iron and dithionite than in the experiments with only one of these.

Without wishing to be bound by any theory, it is proposed that the dithionite reduces the 2Fe³⁺-EDTA via Reaction 13, thus avoiding or reducing passivation of the iron surface by iron hydroxide. The dithionite also provides an environment conducive to reduction of the gold-thiosulfate complex by reducing other oxidised species in solution with a higher (more positive) reduction potential, for example 02.

2Fe³⁺-EDTA+S₂O₄²⁻+4OH⁻→2Fe²⁺-EDTA+2SO₃²⁻+2H₂O (13)

The metallic iron substrate is believed to provide nucleation sites to facilitate the reduction of gold thiosulfate to metallic gold. A portion of the gold undergoes cementation on the iron surface which may produce a small amount of iron hydroxide, per Reaction 10, but the impact of this on the overall gold cementation process is apparently negligible.

### Example 2

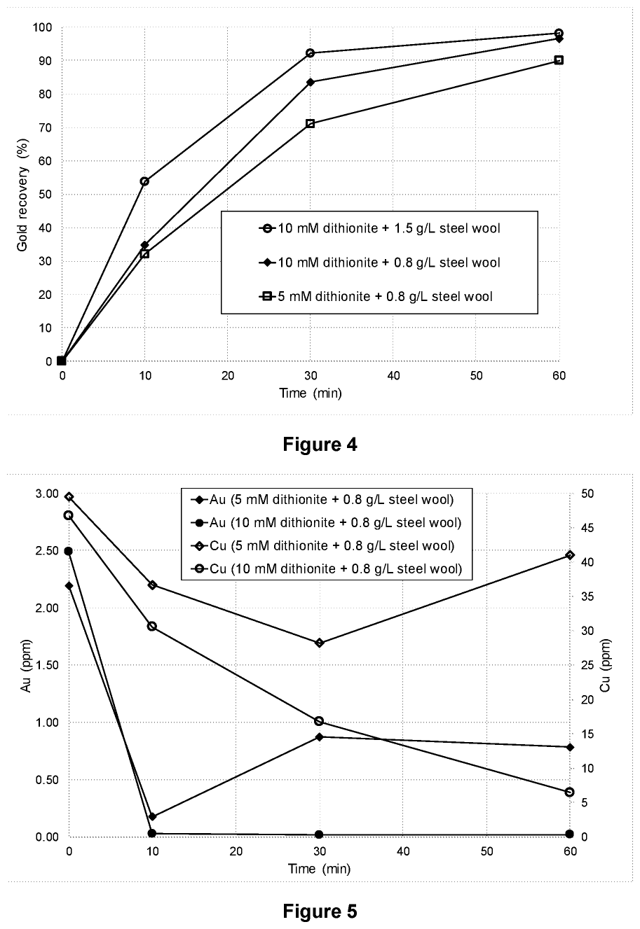

Gold recovery from PLS-1 was investigated, using the same method as in Example 1 but with steel wool (Sifa Coarse grade 2-3 steel wool) instead of iron powder. The results are depicted in FIG. 4. Excellent gold recovery was obtained at a variety of different steel wool and dithionite concentrations.

### Example 3

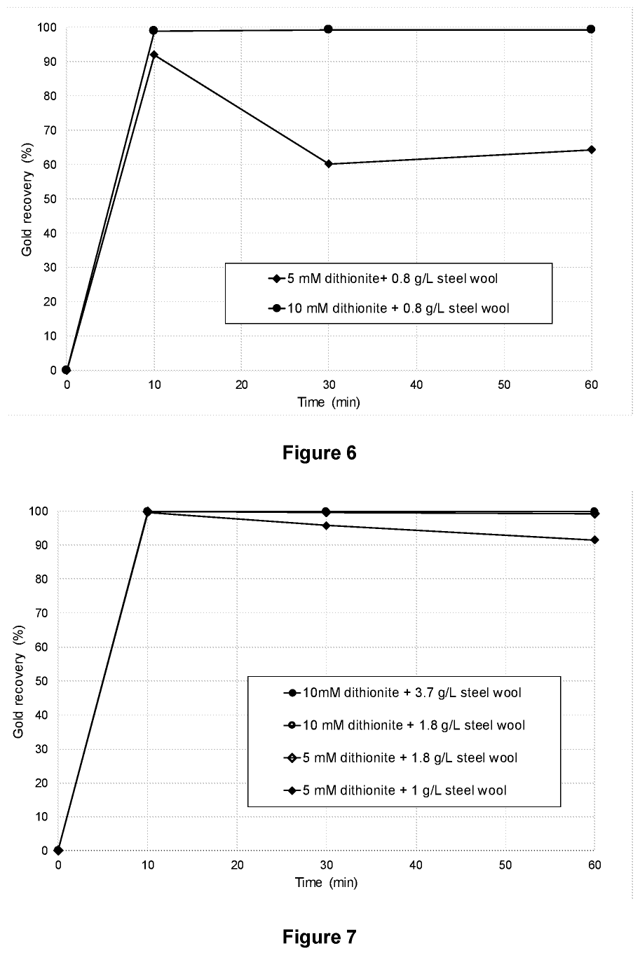

A synthetic thiosulfate-based PLS (hereafter PLS-3) containing both gold and copper was prepared, containing 0.1 mol/L sodium thiosulfate, 3 mmol/L ferric sodium EDTA, thiourea, 2.5 mg/L gold and 50 mg/L copper. Glass bottles (nominal 100 mL volume) were filled with 130 mL of the PLS-3 solution so that minimal headspace remained in the bottle. Steel wool (Sifa Coarse grade 2-3 steel wool, 0.8 g/L) and sodium dithionite (5 or 10 mmol/L) were added to the bottles and the bottles were capped and rolled. Samples (4 mL) were withdrawn and filtered after 0, 10, 30, minutes for gold and copper analysis by ICP. The metal concentrations in solution and the corresponding gold recoveries are shown in FIGS. 5 and 6 respectively.

The presence of copper appeared to enhance the initial rate of gold recovery (compare 10 mmol/L dithionite results in FIGS. 4 and 6), possibly due to the co-reduction or co-cementation of gold/copper alloy. At lower dithionite concentrations, both gold and copper started to re-dissolve during the course of the reaction. It is believed that this was caused by depletion of dithionite during the experiment as a result of oxygen ingress during sampling. The gold and copper metals were thus leached back into the thiosulfate leaching solution. Consistent with this proposal, the solution also reverted from colourless to yellowish, apparently due to re-oxidation of Fe²⁺-EDTA to Fe³⁺-EDTA.

### Example 4

A synthetic thiosulfate-based PLS (hereafter PLS-4) containing a high concentration of gold was prepared, the solution containing 0.1 mol/L sodium thiosulfate, 3 mmol/L ferric sodium EDTA, thiourea and 100 mg/L gold. Glass bottles (nominal 50 mL volume) were filled with 54 mL of the PLS-4 solution so that minimal headspace remained in the bottle. Steel wool (Sifa Coarse grade 2-3 steel wool, in an amount of 1, 1.8 or 3.7 g/L) and sodium dithionite (5 or 10 mmol/L) were added to the bottles and the bottles was capped and rolled. Samples (2 mL) were withdrawn and filtered after 0, 10, 30, 60 minutes for gold analysis by ICP. The results are depicted in FIG. 7.

Almost quantitative gold recovery was achieved within 10 minutes for all the experiments (<0.4 ppm gold remaining in solution). The fast deposition kinetics at high initial gold concentration (100 ppm gold) vs low initial gold concentration (2 ppm gold, c.f. FIG. 4) may be due to a change in the surface characteristics of the cementation substrate as more metallic gold deposits. According to one proposal, the initial gold deposition on the steel wool surface occurs at higher over-potentials, but once the iron surface is covered with gold it is easier for more gold to deposit on the gold surface than on the iron surface. The subsequent re-dissolution of gold in one experiment (5 mmol/L dithionite, 1 g/L steel wool) was again attributed to depletion of the dithionite as a result of oxygen ingress during sampling.

After the experiments, the steel wool was removed from the bottles, rinsed and then subjected to a cyanide leach and analysis to determine the amount of gold cemented to the steel wool. The bottle containing the barren leach solution was exposed to air to allow oxygen ingress, so that any residual metallic gold in the bottle would be re-dissolved. The solution was then analysed to determine the gold content remaining in the bottle. The results indicated that more than 92% of the initial gold in the PLS was cemented as metallic gold on the steel wool, with less than 8% of the gold remaining in the bottle as fine precipitate or gold cemented on residual fine iron scraps.

### Example 5

To investigate whether exclusion of oxygen could allow high gold recoveries at lower dithionite concentrations, further experiments were conducted as described in Example 4, using 5 mmol/L and 3 mmol/L dithionite but without opening the bottle for intermediate sampling before 60 minutes. The results are shown in Table 2. Almost quantitative gold recovery was obtained after 60 minutes.

TABLE 2

| | |
|---|---|
| Dithionite (5 mmol/L) + | Dithionite (3 mmol/L) + |
| Fe powder (1.0 g/L) | Fe powder (1.0 g/L) |

| | Au | Recovery | Au | Recovery |
|---|---|---|---|---|
| Time | (mg/L) | (%) | (mg/L) | (%) |
| 0 | 126.7 | 0.0 | 126.7 | 0.0 |
| 60 | 0.25 | 99.8 | 0.22 | 99.8 |

To induce gold cementation, it appears that dithionite must be dosed at a slight stoichiometric excess compared to oxidising species in solution such as Fe³⁺-EDTA and dissolved O₂. Thus, for example, dithionite dosing of 2-3 mmol/L should be adequate for a PLS containing 3 mmol/L Fe³⁺-EDTA, assuming low oxygen ingress can be maintained (per 1:2 reaction stoichiometry of dithionite: Fe³⁺-EDTA—see equation 13).

### Example 6

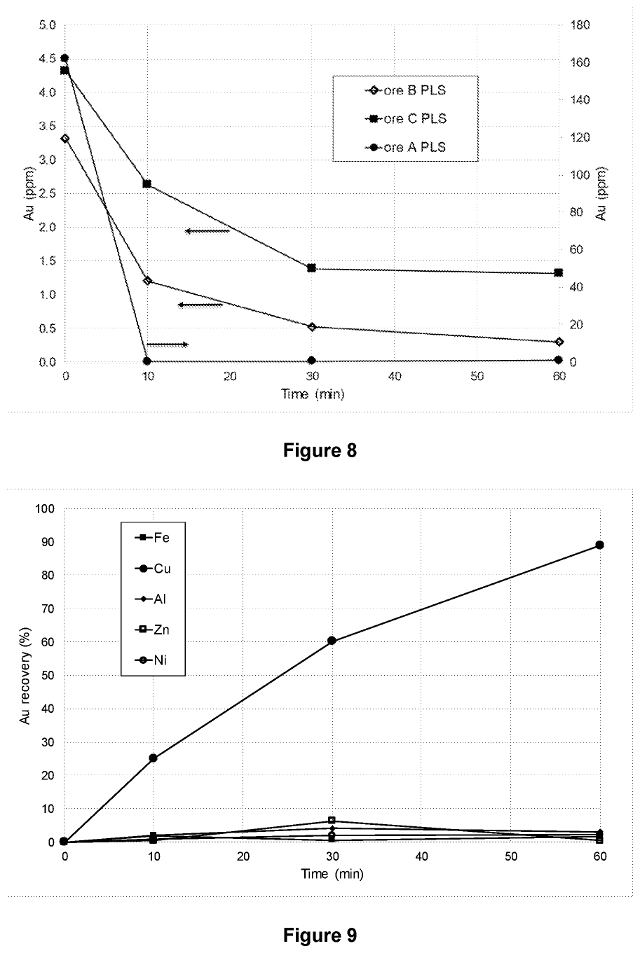

Gold recovery from PLS's resulting from thiosulfate leaching of three gold-bearing ores (ores A, B and C) was investigated using the method of Example 2 with 10 mmol/L dithionite and 1.5 g/L steel wool added to the bottle. The results are shown in FIG. 8. Excellent gold recovery was obtained for both high gold content PLS (ore A, 162 mg/L) and low gold content PLS (ore B, 3.3 mg/L). Recovery from the ore C PLS was kinetically slower, which is likely related to the hypersaline water used in preparing the thiosulfate leach solution (containing 4.2 mol/L Na, 0.8 mol/L Mg and ˜5 mol/L Cl).

### Example 7

The effectiveness of a range of base metals for gold cementation, with and without dithionite, was investigated using iron, zinc, aluminium, nickel and copper metal powders. The particle sizes of the iron, zinc, aluminium and nickel powders were approximately 0.149 mm (or 100 mesh), while the particle size of the copper powder was approximately 0.595 mm (or 30 mesh).

Glass bottles (nominal 100 mL volume) were filled with 130 mL of PLS-1 solution (as used in Example 1) so that minimal headspace remained in the bottle. The metal powders, by themselves or in combination with sodium dithionite, were added to the bottles and the bottles were capped and rolled. Samples (4 mL) were withdrawn and filtered after 0, 10, 30, 60 minutes for gold analysis by ICP. The gold recovery results using the metal powders only, in an amount of 1.54 g/L, are shown in FIG. 9, and the effect on dissolved iron concentration in the PLS is shown in Table 3.

It is evident that iron, zinc, aluminium and nickel powders were ineffective for inducing gold reduction and cementation, whereas copper powder was able to recover gold to a significant degree. However, the use of copper metal as a cementation substrate has the disadvantage that it consumes thiosulfate and introduces dissolved copper species to the leach solution. This is believed to take place via reaction with both Fe³⁺-EDTA (Reaction 14) and dissolved oxygen (Reaction 8). Analysis of the leach solution after gold recovery with copper metal indicated a copper content of 378 mg/L, corresponding to a thiosulfate consumption of approximately 18 mmol/L. Moreover, copper leaching via Reaction 8 is expected to increase the solution pH, and it was indeed observed that the PLS pH increased from 6.5 to 10.5 after gold recovery on copper. At such high pH values the iron-EDTA complex is unstable, and this is believed to be the reason for the loss of iron in solution (see Table 3).

Fe³⁺-EDTA+Cu+3S₂O₃²⁻Fe²⁺-EDTA+Cu(S₂O₃)₃⁵⁻ (14)

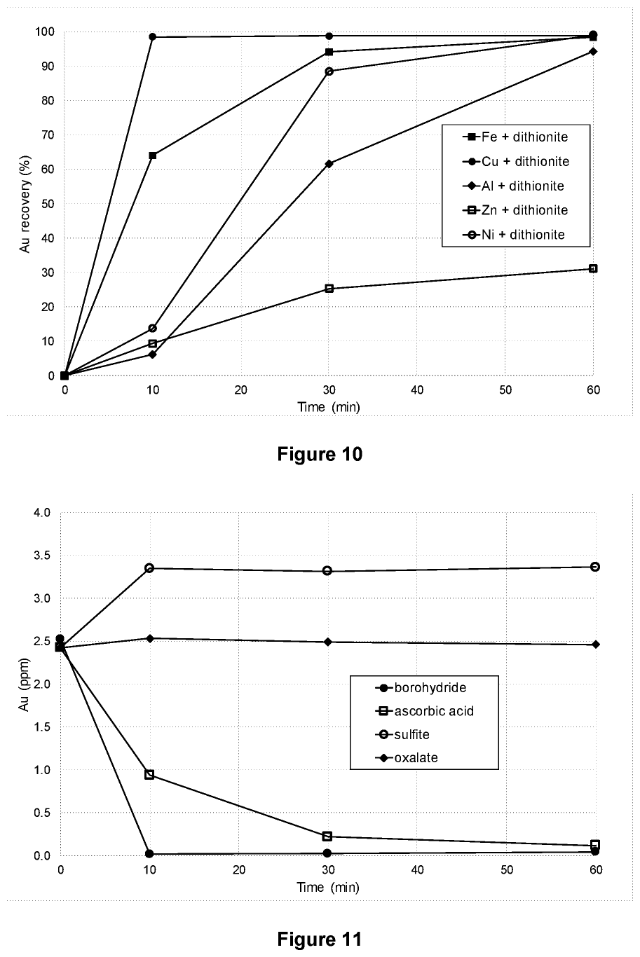

The gold recovery results when using both the metal powders (1.54 g/L) and dithionite (10 mmol/L) are shown in FIG. 10, and the change in dissolved iron concentration in the PLS is also shown in Table 3. The results demonstrate significantly enhanced gold recovery for all metals, with close to quantitative gold recovery in 60 minutes with each of copper, iron, nickel and aluminium. Zinc was less effective, but still achieved 30% recovery. The gold recovery kinetics follow the order of: Cu>Fe>Ni>Al>>Zn.

The disadvantages of copper metal as a cementation substrate were significantly reduced when dithionite was present. Only 42 mg/L copper dissolved by 60 minutes, at which point the leaching solution pH was only 5.7. This improvement is attributed to preferential reduction of Fe³⁺-EDTA and dissolved oxygen by dithionite, instead of by copper. The iron species in solution were also substantially stable since there was little increase in solution pH. The use of zinc caused a slight loss of iron in solution, as zinc competition for EDTA causes decomposition and precipitation of the iron species. By contrast, the iron content was stable with both nickel and aluminium metals powders.

TABLE 3

| Time | Iron content in the PLS before/after gold recovery (mg/L) | | | | |
|---|---|---|---|---|---|
| (min) | Fe powder | Cu powder | Al powder | Zn powder | Ni powder |
| 0 | 133 | 133 | 133 | 133 | 133 |
| 60 | 136 | 95 | 134 | 122 | 134 |
| | Fe powder + | Cu powder + | Al powder + | Zn powder + | Ni powder + |
| | dithionite | dithionite | dithionite | dithionite | dithionite |
| 0 | 133 | 133 | 133 | 133 | 133 |
| 60 | 187 | 128 | 131 | 106 | 132 |

### Example 8

The effectiveness of a range of alternative soluble reducing agents to induce gold cementation was investigated, using iron powder with particle size of approximately 0.149 mm (or 100 mesh) as the cementation substrate. Sodium borohydride, ascorbic acid, sodium oxalate and sodium sulfite were used as test reagents in the experiments.

Glass bottles (nominal 100 mL volume) were filled with 130 mL of PLS-1 solution (as used in Example 1) so that minimal headspace remained in the bottle. Iron metal powder (1.54 g/L) and the soluble reducing agent (10 mmol/L) were added to the bottles and the bottles were capped and rolled. Samples (4 mL) were withdrawn and filtered after 0, 10, 30, 60 minutes for gold analysis by ICP. The gold reduction results are shown in FIG. 11, and the effect on dissolved iron concentration in the PLS is shown in Table 4.

Borohydride and ascorbic acid were both effective in inducing cementation of gold on the iron powder, achieving about 98% and 95% gold recovery in 60 minutes respectively. The reduction kinetics were faster with borohydride due to its negative reduction potential, although formation of hydrogen bubbles due to reaction with water could also be observed. The use of ascorbic acid appeared to cause a significant increase in iron concentration in the solution (Table 1), which was not observed with the other reagents. Sulfite and oxalate were ineffective to induce gold reduction. Based on a change of the solution colour from yellow to orange, it appeared that sulfite formed a new metal species in solution, possibly by reaction with Fe-EDTA.

TABLE 4

| Time | Iron content in the PLS before/after gold recovery (mg/L) | | | |
|---|---|---|---|---|
| (min) | Borohydride | Ascorbic acid | Oxalate | Sulfite |
| 0 | 133 | 133 | 133 | 133 |
| 60 | 131 | 233 | 140 | 131 |

### Example 9

A synthetic gold-bearing PLS (hereafter PLS-9) was prepared to simulate gold recovery from an oxygen-thiosulfate leaching system. PLS-9 contained 0.1 mol/L calcium thiosulfate, 2 mmol/L copper (added as CuSO₄ but converted to copper thiosulfate instantly) and ˜2.5 mg/L gold (added as sodium gold thiosulfate), with the pH adjusted to 10 by addition of NaOH. Glass bottles (nominal 100 mL volume) were filled with 130 mL of the PLS-9 solution so that minimal headspace remained in the bottle. Iron metal powder (1.54 g/L, particle size 0.149 mm or 100 mesh), or sodium dithionite (10 mmol/L), or both, were added to the bottles, and the bottles were capped and rolled. Samples (4 mL) were withdrawn and filtered after 0, 10, 30, 60 minutes for gold analysis by ICP.

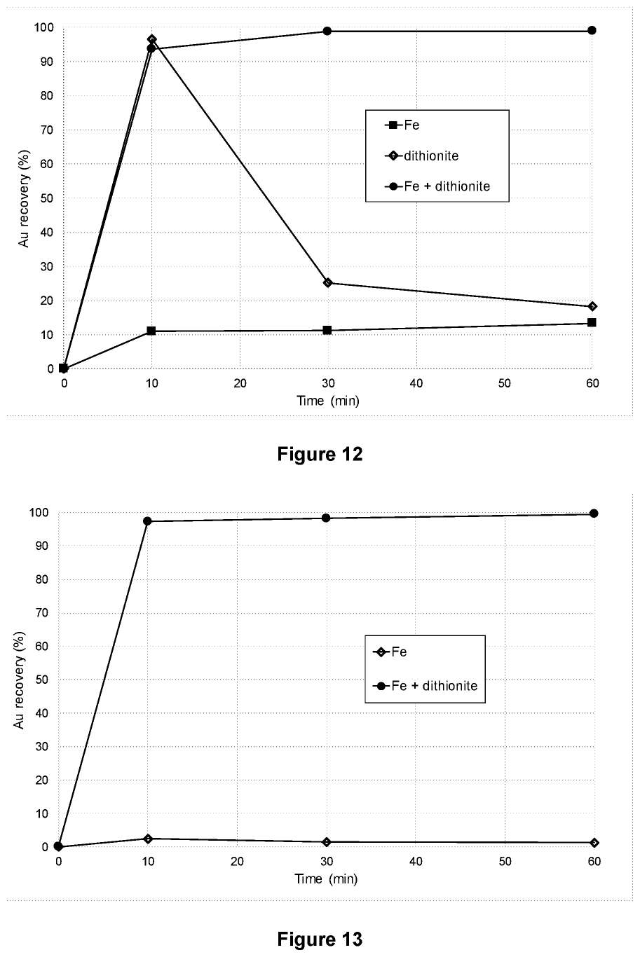

The gold recovery results are depicted in FIG. 12. For this leaching system also, iron metal alone was ineffective for gold recovery. Dithionite alone achieved 97% gold recovery in 10 minutes. However, the recovered gold started to redissolve thereafter, suggesting that higher dosages of dithionite are required to maintain a reducing environment. Moreover, the resultant fine gold precipitate is difficult to recover by filtration.

When both iron and dithionite were used, ˜99% gold recovery was achieved in 30 minutes and gold redissolution did not occur by 60 minutes. The copper concentration decreased from 126 mg/L to 5 mg/L in 60 minutes, suggesting that copper metal is simultaneously recovered. The pH of the barren solution decreased to 5.6, which was ascribed to hydroxide consumption via Reaction 10 between gold thiosulfate and iron metal and/or Reaction 12 between gold thiosulfate and dithionite. The decrease in pH is expected to be less for lower dosages of dithionite. The formation and precipitation of any Fe(OH)₂ had little or no impact on the overall gold cementation process.

Similar results (>98% gold recovery with no re-dissolution) were obtained in a further experiment where only 5 mmol/L of dithionite was used.

### Example 10

The effectiveness of a range of base metals for dithionite-mediated gold cementation from synthetic oxygen-thiosulfate PLS-9 was investigated using iron, zinc, aluminium, nickel and copper metal powders. The method of Example 7 was followed.

Iron, aluminium and nickel powders (1.54 g/L) were ineffective for inducing gold reduction and cementation. Copper powder (1.54 g/L) was able to recover gold to a significant degree (95% recovery after 30 minutes), while zinc powder (1.54 g/L) with this system was somewhat effective although at lower rates (70% recovery after 60 minutes).

When using both metal powders (1.54 g/L) and dithionite (10 mmol/L), significantly enhanced gold recovery was obtained for all metals. For iron, nickel, copper and zinc, greater than 93% recovery was obtained in 10 minutes and near quantitative recovery by 30 minutes. With aluminium powder, 97% recovery was obtained in 10 minutes, although the gold re-dissolved later in the experiment.

### Example 11

The effectiveness of a range of alternative soluble reducing agents to induce gold cementation from synthetic oxygen-thiosulfate PLS-9 was investigated, using iron powder as the cementation substrate. Sodium borohydride, ascorbic acid, sodium oxalate and sodium sulfite were used as test reagents in the experiments, and the method of example 8 was followed. Borohydride and ascorbic acid were both effective in inducing cementation of gold on the iron powder, achieving above 97% gold recovery in 60 minutes. The reduction kinetics were faster with borohydride. Sulfite and oxalate were again ineffective to induce gold reduction.

### Example 12

A synthetic gold-bearing PLS (hereafter PLS-12) was prepared to simulate gold recovery from a copper-ammonia thiosulfate leaching system. PLS-12 contained 0.2 mol/L ammonium thiosulfate, 3 mmol/L copper (added as CuSO₄) and ˜3 mg/L gold (added as sodium gold thiosulfate), with the pH adjusted to 9.5 by addition of NaOH. Glass bottles (nominal 100 mL volume) were filled with 130 mL of the PLS-12 solution so that minimal headspace remained in the bottle. Iron metal powder (1.54 g/L, particle size 0.149 mm or 100 mesh), by itself or in combination with sodium dithionite (10 mmol/L), was added to the bottles, and the bottles were capped and rolled. Samples (4 mL) were withdrawn and filtered after 0, 10, 30, 60 minutes for gold analysis by ICP.

The gold recovery results are depicted in FIG. 13. For this leaching system also, iron metal alone was ineffective for gold recovery. However, nearly quantitative gold recovery was obtained when using both iron and dithionite. Some copper was simultaneously recovered, as indicated by a decrease in the copper concentration from 177 mg/L to 104 mg/L over the 60-minute time period. No change in the pH occurred during the recovery process. It is expected that the residual copper in solution is in the form of copper thiosulfate complexes, which can be regenerated back to copper-ammine species using oxygen once all dithionite has been oxidised.

### Example 13

A synthetic gold-bearing PLS (hereafter PLS-13) was prepared to simulate gold recovery from a high gold content copper-ammonia thiosulfate leaching system, for example a PLS from leaching a gravity concentrate. PLS-13 contained 0.5 mol/L ammonium thiosulfate, 5 mmol/L copper (added as CuSO₄) and ˜84 mg/L gold (added as sodium gold thiosulfate), with the pH adjusted to 10 by addition of NaOH. Gold recovery was then investigated using iron powder (1.54 g/L) and dithionite (10 mmol/L), following the method of example 12. The cementation process was very rapid, with near quantitative gold recovery obtained by 10 minutes. Approximately half of the copper was also recovered in the 60-minute experiment (reduction from 238 mg/L to 111 mg/L).

### Example 14 (Comparative)

Two synthetic gold-bearing PLS's (hereafter PLS-14a and PL-14b) were prepared to simulate gold recovery from cyanide-based (non-thiosulfate) leaching systems. PLS-14a contained 10 mmol/L cyanide and ˜2 mg/L gold. PLS-14b contained 10 mmol/L cyanide, 65 ppm copper, and ˜20 mg/L gold. Glass bottles (nominal 100 mL volume) were filled with 130 mL of the PLS-14a and b solutions so that minimal headspace remained in the bottle. Iron metal powder (0.8 or 1.54 g/L, particle size 0.149 mm or 100 mesh) and sodium dithionite (5 or 10 mmol/L) were added to the bottles, and the bottles were capped and rolled. Samples (4 mL) were withdrawn and filtered after 0, 10, 30, 60 minutes for gold analysis by ICP.

The results indicated that the gold in PLS-14a and PLS-14b was not reduced, and it is concluded that the combination of iron and dithionite is ineffective for recovering gold from cyanide-based leaching solutions.

### Example 15 (Comparative)

A gold thiourea PLS (hereafter PLS-15) was prepared using a rotating gold disc electrode (RDE; 1.5 mm i.d.) and a thiourea leach solution (containing 0.1 mol/L H₂SO₄, 5 mmol/L FeCl₃, 55 mmol/L oxalic acid and 65 mmol/L thiourea at pH of about 1). Gold leaching was stopped at approximately 30 minutes when the solution gold concentration reached 5.8 mg/L, and the resultant PLS-15 was used for subsequent gold recovery tests. Glass bottles (nominal 100 mL volume) were filled with 130 mL of the PLS-15 solution so that minimal headspace remained in the bottle. Iron metal powder (1.54 g/L, particle size 0.149 mm or 100 mesh), by itself or with sodium dithionite (10 mmol/L), was added to the bottles, and the bottles were capped and rolled. Samples (4 mL) were withdrawn and filtered after 0, 10, 30, 60 minutes for gold analysis by ICP.

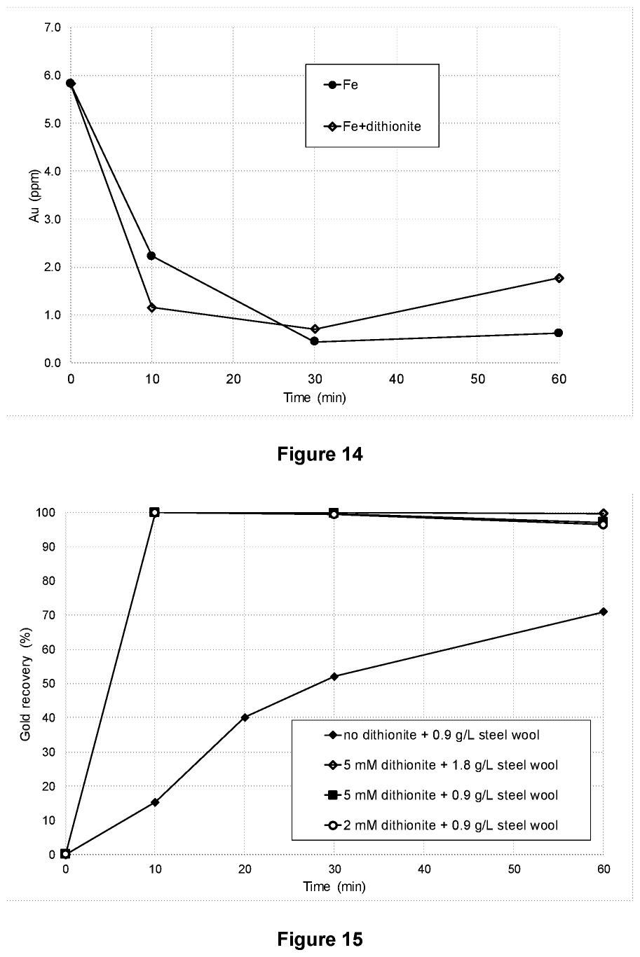

The gold recovery results shown in FIG. 14 indicate that the use of iron powder alone worked moderately well to recover gold (the gold concentration decreased from 5.8 mg/L to 0.4 mg/L in 30 minutes). The use of dithionite in combination with the iron enhanced the gold recovery kinetics slightly for the first 10 minutes, but the overall recovery was worse than for iron powder alone because the recovered gold started to redissolve after 30 minutes. It is believed that the acidic conditions caused dissolution of the iron and decomposition of the dithionite.

### Example 16 (Comparative)

A gold thiocyanate PLS (hereafter PLS-16) was prepared using a rotating gold disc electrode (RDE; 1.5 mm i.d.) and a thiocyanate leach solution (5 mmol/L H₂SO₄, 5 mmol/L KSCN and 50 mmol/L FeCl₃ at pH of about 1.4). Gold leaching was stopped at approximately 60 minutes when the solution gold concentration reached 3.5 mg/L, and the resultant PLS-16 was used for subsequent gold recovery tests. Gold recovery from PLS-16 was then tested by the same method as in Example 15. The iron powder was found to be more effective than the combination of iron and dithionite, which achieved less than 50% gold recovery after 30 minutes.

### Example 17

Synthetic gold- and silver-bearing PLS's (hereafter PLS-17a and PLS-17b) were prepared to simulate simultaneous gold and silver recovery from Fe-EDTA thiosulfate and oxygen thiosulfate leaching systems respectively. PLS-17a contained mol/L sodium thiosulfate, 3 mmol/L ferric sodium EDTA, thiourea, 2.5 mg/L gold added as sodium gold thiosulfate and 39 ml/L silver (added as AgNO₃), at a pH of between 6 and 7. PLS-17b contained 0.1 mol/L calcium thiosulfate, 2 mmol/L copper (added as CuSO₄ but converted to copper thiosulfate instantly), ˜2.5 mg/L gold (added as sodium gold thiosulfate) and 25 mg/L silver, with the pH adjusted to 10 by addition of NaOH.

Glass bottles (nominal 100 mL volume) were filled with 130 mL of the PLS-17a and 17b solutions so that minimal headspace remained in the bottle. Iron metal powder (1.54 g/L) and sodium dithionite (10 mmol/L) were added to the bottle and the bottles were capped and rolled. Samples (4 mL) were withdrawn and filtered after 0, 30, 60 minutes for gold analysis by ICP.

Both gold and silver were quantitatively recovered after 10 minutes from PLS-17a. With PLS-17b, silver recovery was complete by 10 minutes and gold was near-quantitatively recovered after 30 minutes. No re-dissolution of either metal occurred over the 60 minute experiments. The results demonstrate that silver can also be recovered efficiently with the methods of the invention.

### Example 18

A synthetic gold-bearing resin eluate (hereafter RE-18) was prepared to simulate gold recovery from a resin eluate produced by eluting a strong base ion-exchange resin loaded with gold-thiosulfate using a sulfite-chloride eluant. RE-18 contained 1.8 mol/L NaCl, 60 mmol/L SO₃²⁻, 150 mmol/L S₂O₃²⁻, 70 mmol/L S₃O₆²⁻ and ˜100 ppm Au (as sodium gold thiosulfate). Glass bottles (nominal 50 mL volume) were filled with 54 mL of the RE-18 solution so that minimal headspace remained in the bottle. Steel wool (Sifa Coarse grade 2-3 steel wool, 0.9 or 1.8 g/L), by itself or together with sodium dithionite (2 or 5 mmol/L) were added to the bottles and the bottles was capped and rolled. Samples (2 mL) were withdrawn and filtered after 0, 10, 30, 60 minutes for gold analysis by ICP. The results are depicted in FIG. 15.

Gold reduction with steel wool alone was slow and only reached ˜70% recovery in one hour. By contrast, the combination of iron metal and dithionite was highly effective in recovering gold. Almost quantitative gold recovery was achieved in minutes for all experiments, with as little as 2 mmol/L dithionite. The recovered gold remained undissolved for the duration of the experiment when using 5 mmol/L dithionite and 1.8 g/L steel wool, but started to re-dissolve by 60 minutes when using 5 mmol/L dithionite and 0.9 g/L steel wool or 2 mmol/L dithionite and 0.9 g/L steel wool. This phenomenon was again ascribed to the depletion of dithionite as a result of oxygen ingress during sampling, and it is expected that dissolution of cemented gold can be avoided by minimising oxygen ingress.

Good gold recoveries could be obtained with lower amounts of dithionite than for the synthetic thiosulfate PLS. This is because the resin eluate contains no Fe³⁺-EDTA that must be reduced before gold reduction commences, and possibly also because the resin eluate already contains sulfite which can remove dissolved oxygen and thus assist in maintaining a reducing environment.

### Example 19

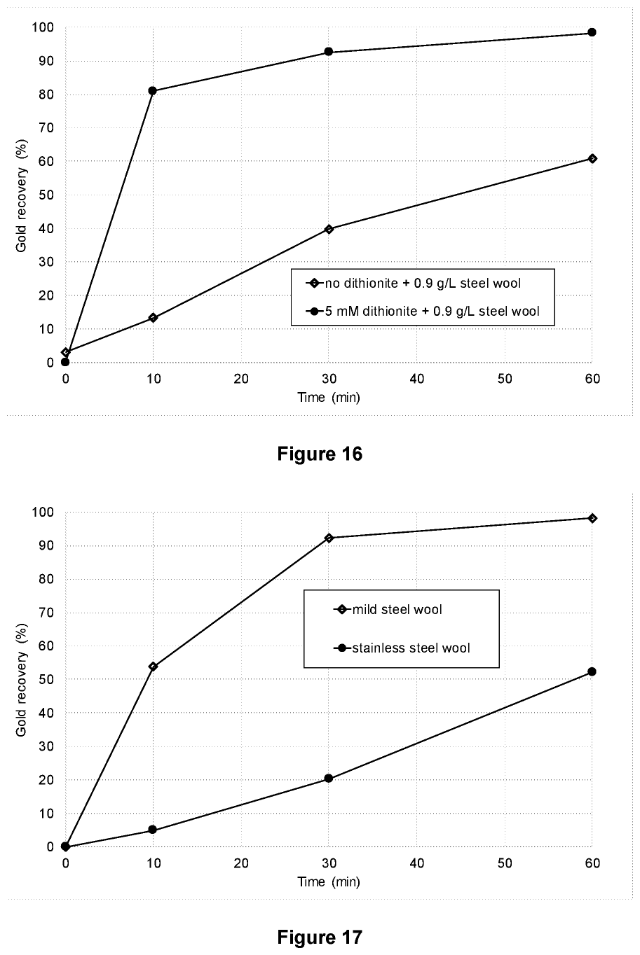

A synthetic gold-bearing resin eluate (hereafter RE-19) was prepared to simulate gold recovery from a resin eluate produced by eluting a strong base ion-exchange resin loaded with gold-thiosulfate using a sulfite-trithionate eluant. RE-19 contained 120 mmol/L S₃O₆²⁻, 120 mmol/L SO₃²⁻, 150 mmol/L S₂O₃²⁻ and ˜100 ppm Au (as sodium gold thiosulfate). Gold recovery with steel wool (0.9 g/L), or steel wool (0.9 g/L) and dithionite (15 mmol/L), was then evaluated using the method of Example 18 and the results are shown in FIG. 16.

Gold reduction by steel wool alone was again slow and incomplete after 60 minutes, but the combination of iron metal and dithionite was highly effective in recovering gold. Almost complete gold recovery (>98%) was achieved in 60 minutes, although the kinetics of gold recovery was somewhat slower than for the sulfite-chloride eluate tested in Example 18.

### Example 20

The effect of the reducing agent stoichiometry on the gold cementation process was investigated using PLS-1, a synthetic Fe-EDTA thiosulfate PLS as prepared in Example 1, and PLS-9, a synthetic oxygen-thiosulfate PLS as prepared in Example 9. Glass bottles (nominal 100 mL volume) were filled with 130 mL of PLS-1 or PLS-9 so that minimal headspace remained in the bottle. Steel wool (Sifa Coarse grade 2-3 steel wool, 1.5 g/L) and reducing agent (dithionite, borohydride or ascorbic acid in various concentrations) were added to the bottles and the bottles were capped and rolled for one hour without interval sampling. The steel wool was then removed from the bottles, rinsed and subjected to a cyanide leach and analysis to determine the amount of gold cemented to the steel wool. The bulk solution was filtered and the filter cake was subjected to a separate cyanide leach to determine the amount of gold in fine precipitates. The results are shown in Table 5.

TABLE 5

| | | Reducing | Au (mg/L) | | | | % of reduced Au | |
|---|---|---|---|---|---|---|---|---|
| | | agent | In | In barren | In steel | In filter | On | |
| | Reducing | conc | initial | leach | wool | cake | steel | In fine |
| PLS | agent | (mmol/L) | PLS | solution | leachate | leachate | wool | precipitate |
| 9 | dithionite | 5 | 2.01 | 0.07 | 0.93 | 2.36 | 28 | 72 |
| 9 | dithionite | 0.5 | 2.02 | 0.32 | 3.66 | 0.29 | 93 | 7 |
| 9 | dithionite | 0.3 | 2.02 | 1.24 | 1.97 | 0.05 | 97 | 3 |
| 1 | borohydride | 10 | 2.11 | 0.12 | 0.16 | 2.97 | 5 | 95 |
| 1 | borohydride | 1 | 2.50 | 1.64 | 1.49 | 0.73 | 67 | 33 |
| 1 | ascorbic acid | 10 | 2.11 | 0.21 | 3.74 | 0.10 | 97 | 3 |
| 1 | dithionite | 10 | 2.08 | 0.08 | 3.49 | 0.35 | 91 | 9 |
| 1 | dithionite | 3 | 2.08 | 0.12 | 3.64 | 0.24 | 94 | 6 |

For thiosulfate-oxygen PLS-9, the use of 5 mmol/L of dithionite resulted in 72% of the reduced gold reporting to fine precipitates. The dithionite in this case was in a large excess as very little oxidant (as dissolved oxygen) was present in the PLS. The resultant strong reducing environment favoured homogeneous reduction and thus the formation of fine precipitates. However, when the dithionite was reduced to 0.5 mmol/L and 0.3 mmol/L, the formation of fine precipitates was significantly reduced to 7% and 3%, respectively.

For Fe-EDTA thiosulfate PLS-1, the use of 10 mmol/L borohydride caused 95% of the reduced gold to report to fine precipitates. As borohydride is a very strong reducing agent, the addition of excess borohydride favoured homogeneous precipitation. However, by control of the stoichiometric excess, cementation onto steel wool was favoured. Thus, only 33% of the reduced gold was present in fine precipitates when 1 mmol/L borohydride was used.

With ascorbic acid, a mild reducing agent, cementation was strongly favoured over homogeneous precipitation. Thus, 97% of the reduced gold was cemented on the steel wool despite the use of a large excess (10 mmol/L) of ascorbic acid. Cementation was also favoured with dithionite, with over 90% of the reduced gold cemented at both 3 mmol/L and 10 mmol/L.

### Example 21

The effect of the base metal reactivity in the cementation substrate was investigated by comparing dithionite-mediated gold cementation on mild steel wool (Sifa Coarse grade 2-3 steel wool) and stainless steel wool (Jex Industries Pty Ltd type 316L), using PLS-1 as prepared in Example 1 and the methodology of Example 2. The results are shown in FIG. 17. It is evident that gold reduction was rapid in the presence of the mild steel substrate. In the presence of the stainless steel substrate, reduction was much slower although reduced gold still cemented on the substrate. Without wishing to be limited by theory, it is proposed that the slower cementation kinetics on stainless steel is due to the more inert form of the iron, by contrast to the more readily oxidised iron in mild steel.

### Example 22

Various amounts of sodium dithionite were added to synthetic gold-bearing PLS-1 (as used in Example 1) in the presence of 1.5 g/L steel wool. PLS-1 contained 3 mmol/L of oxidant, i.e. ferric sodium EDTA. Table 6 shows the oxidation-reduction potential (Eh) of the resultant solutions as measured using a platinum ORP (Oxidation-Reduction-Potential) electrode. The presence of unreduced ferric sodium EDTA is evident from the solution colour and the Eh. Once sufficient dithionite is added to deplete the oxidant, so that residual/free dithionite is present, the solution is colourless and a sudden drop in EH to below −400 mV occurs.

TABLE 6

| | | | | | | |
|---|---|---|---|---|---|---|
| Dithionite | 0 | 1 | 2 | 3 | 5 | 10 |
| addition | | | | | | |
| (mmol/L) | | | | | | |
| Residual | 0 | 0 | 0.2 | 1.2 | 3.2 | 8.2 |
| dithionite | | | | | | |
| (mmol/L)^{a} | | | | | | |
| Eh (mV) | 4 | −90 | −420 | −480 | −520 | −530 |
| Colour | Light | Lighter | Colour- | Colour- | Colour- | Colour- |
| | yellow | yellow | less | less | less | less |

^{a}residual dithionite is the calculated amount of dithionite remaining after depletion of all oxidants, including Fe³-EDTA and O₂ (5 ppm measured using a dissolved oxygen meter).

### Example 23

Glass bottles (nominal 100 mL volume) were filled with 130 mL of the PLS-1 solution so that minimal headspace remained in the bottle. The effect of dithionite and steel wool addition and stoichiometry on gold reduction was then investigated in four experiments. In each experiment, the Eh of the solution when commencing reduction was measured using a platinum ORP electrode. The bottles were then capped and rolled. Samples (4 mL) were withdrawn and filtered after 0, 10, 30, 60 minutes for gold analysis by ICP.

In experiment 23-1, steel wool (Sifa Coarse grade 2-3; 1.5 g/L) was added to the bottle to allow cementation in the absence of any dithionite addition. In experiment 23-2, dithionite was added carefully until the solution had only very faint yellow colouration and Eh was −120 mV. Thereafter, the steel wool (1.5 g/L) was added to initiate cementation. Because dithionite and ferric iron-EDTA react near-instantaneously, the solution subjected to cementation was free of dithionite and most (but not all) of the oxidant was pre-reduced before introduction of the steel wool. In experiment 23-3, excess dithionite (5 mmol/L) and steel wool (1.5 g/L) were added to the bottle concurrently. The resultant solution was colourless and Eh was −510 mV. In experiment 23-4, dithionite (5 mmol/L) was added to the bottle and homogeneous reduction was conducted in the absence of steel wool. The resultant solution was colourless and Eh was −510 mV.

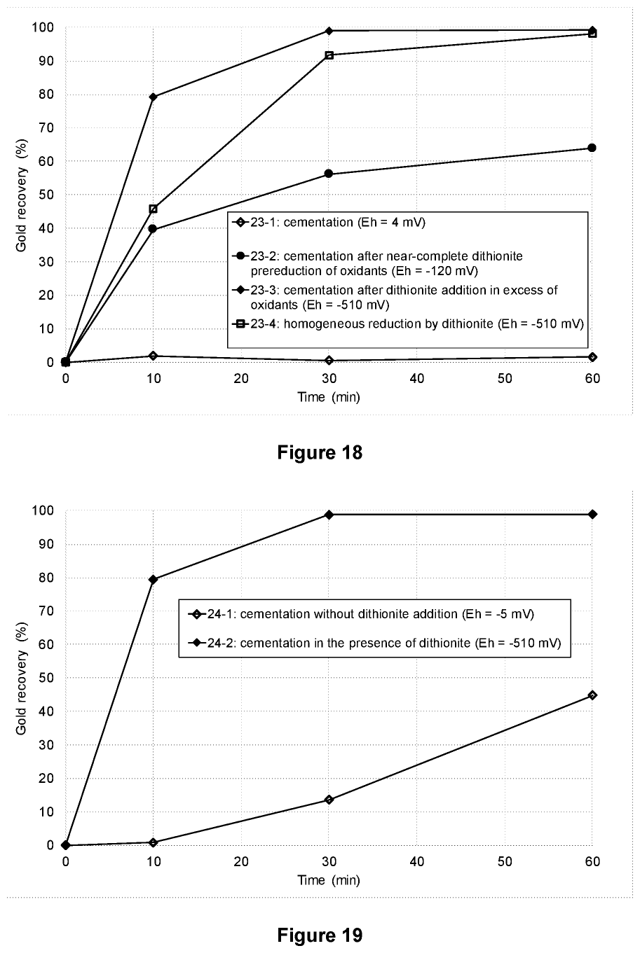

The gold recoveries from solution are shown in FIG. 18. Cementation is the absence of dithionite addition (experiment 23-1) was ineffective, and remained unsatisfactory when dithionite was added in an amount sufficient only to pre-reduce most of the ferric iron-EDTA oxidant (experiment 23-2; 64% recovery after 1 hour). By contrast, when cementation was conducted in the presence of free dithionite, significantly enhanced gold recovery was obtained (near quantitative recovery after 30 minutes) and the reduced gold was deposited in high yield on the steel wool cementation substrate. The cementation recovery rate was superior to the rate of homogenous dithionite reduction (experiment 23-4), which produces fine gold precipitates. Nevertheless, the significant rate of homogeneous reduction indicates a risk of undesirable homogeneous precipitation if the reducing agent is added in excess of the oxidants a significant time before contact with the cementation substrate, and highlights the surprising finding that gold cementation is highly selective (compared to homogeneous precipitation) in the process of the invention.

### Example 24

The effect of dithionite addition on gold cementation of an oxidant-free PLS was investigated using PLS-9 (as used in Example 9). Glass bottles (nominal 100 mL volume) were filled with 130 mL of the PLS-9 solution so that minimal headspace remained in the bottle, and the solution was degassed with N₂ to remove any dissolved O₂. In experiment 24-1, steel wool (Sifa Coarse grade 2-3; 1.5 g/L) was added to the bottle to allow cementation in the absence of any dithionite addition, and the Eh of the resultant solution was −5 mV. In experiment 24-2, excess dithionite (5 mmol/L) and steel wool (1.5 g/L) were added to the bottle concurrently, and the Eh of the resultant solution was −510 mV. The bottles were then capped and rolled. Samples (4 mL) were withdrawn and filtered after 0, 10, 30, 60 minutes for gold analysis by ICP.

The gold recoveries from solution are shown in FIG. 19. Cementation in the absence of dithionite addition (experiment 23-4) was slow (45% recovery after 1 hour), despite the absence of oxidants in solution. By contrast, when cementation was conducted in the presence of free dithionite, significantly enhanced gold recovery was obtained (near quantitative recovery after 30 minutes) and the reduced gold was deposited in high yield on the steel wool cementation substrate.

### Example 25

An aqueous silver thiosulfate solution was prepared as described in GB 1371563 A. The solution contained 3.3 g/L AgCl (2500 ppm Ag), 5.0 g/L Na₄-EDTA (13 mmol/L), 30 g/L NaFeEDTA (82 mmol/L ferric-EDTA), 55 g/L Na₂HPO₄, 5 g/L Na₂SO₃ and 100 g/L (NH₄)₂S₂O₃ (680 mmol/L thiosulfate). The pH of the solution was 7.25 and was adjusted to pH 5.5 with acetic acid. The solution was a dark red colour due to the high concentration of ferric-EDTA and the Eh of the solution was measured as −82 mV using a platinum ORP electrode.

A solution of dithionite was then added slowly to the solution. The solution Eh decreased gradually and dithionite addition was terminated when Eh was −201 mV. The solution colour changed to pale yellow, but remained more strongly coloured at −201 mV than PLS-1 (as used in Example 1) which contained 3 mmol/L ferric EDTA. It was concluded that this dithionite treated silver solution contained at least 3 mmol/L residual ferric-EDTA. Moreover, because the reaction between dithionite and ferric-EDTA is near-instantaneous, no residual dithionite was present.

Addition of a small further increment of dithionite changed the solution to colourless with a sharp drop in Eh to −305 mV, consistent with the depletion of the oxidant and the presence of free dithionite in solution.

Those skilled in the art will appreciate that the invention described herein is susceptible to variations and modifications other than those specifically described. It is understood that the invention includes all such variations and modifications which fall within the spirit and scope of the present invention.

1. A process for recovering precious metal from an aqueous solution comprising thiosulfate and at least one precious metal selected from gold and silver, the process comprising:
introducing a soluble reducing agent to the aqueous solution in excess of any oxidants present in the aqueous solution;
contacting the aqueous solution with a cementation substrate comprising a metallic composition comprising a base metal, wherein the precious metal is reduced in the presence of the reducing agent and the cementation substrate so that reduced precious metal deposits on the cementation substrate to form a precious metal cementation product;
separating the precious metal cementation product from a precious metal-lean aqueous solution comprising the thiosulfate; and
recovering precious metal from the precious metal cementation product.

2. The process according to claim 1, wherein the aqueous solution is a hydrometallurgical process stream.

3. The process according to claim 1, wherein the aqueous solution comprises the precious metal in an amount of less than 2000 ppm.

4. The process according to claim 1, wherein the aqueous solution comprises one or more oxidants and wherein the aqueous solution is contacted with the cementation substrate before depleting the one or more oxidants with the soluble reducing agent.

5. The process according to claim 1, wherein at least 70% of the precious metal reduced in the presence of the reducing agent and the cementation substrate is present in the precious metal cementation product.

6. The process according to claim 1, wherein the precious metal comprises gold.

7. The process according to claim 1, wherein the soluble reducing agent has a standard reduction potential (E⁰) in the range of −1.7V to +0.4V.

8. The process according to claim 1, wherein the soluble reducing agent is selected from the group consisting of dithionite, ascorbic acid, borohydride, hydrazine, hydroxylamine, and combinations thereof.

9. The process according to claim 1, wherein the soluble reducing agent comprises dithionite.

10. The process according to claim 1, wherein the soluble reducing agent is introduced to the aqueous solution in an amount in the range of 0.1 mmol/litre to 50 mmol/litre.

11. The process according to claim 1, wherein the base metal is selected from iron, copper, aluminium, nickel and zinc.

12. The process according to claim 1, wherein the metallic composition comprises a base metal selected from iron, aluminium and nickel.

13. The process according to claim 1, wherein the metallic composition comprises iron.

14. The process according to claim 13, wherein the metallic composition is configured as a plate, rod, powder, mesh or wool.

15. The process according to claim 1, wherein the aqueous solution comprising thiosulfate and at least one precious metal is a pregnant leach solution.

16. The process according to claim 15, wherein the pregnant leach solution comprises thiosulfate in a concentration of from 0.02 mol/litre to 1 mol/litre.

17. The process according to claim 15, wherein the pregnant leach solution comprises at least one oxidant selected from Fe(III), Cu(II) and O₂.

18. The process according to claim 15, wherein the pregnant leach solution comprises an oxidant selected from Cu—NH₃ and Fe-EDTA.

19. The process according to claim 15, further comprising recycling at least a portion of the precious metal-lean aqueous solution to a thiosulfate-based lixiviant for leaching precious metal from a precious metal-bearing solid material.

20. The process according to claim 1, wherein the aqueous solution comprising thiosulfate and at least one precious metal is an ion-exchange resin eluate.

21. The process according to claim 20, wherein the ion-exchange resin eluate comprises at least one selected from sulfite, bisulfite and metabisulfite.

22. The process according to claim 20, wherein the ion-exchange resin eluate comprises at least one displacement anion selected from trithionate, chloride, bromide, thiocyanate and nitrate.

23. The process according to claim 20, further comprising recycling at least a portion of the precious metal-lean aqueous solution to an aqueous eluant for eluting precious metal from a loaded ion-exchange resin comprising precious metal-thiosulfate.

24. The process according to claim 1, wherein the precious metal-lean aqueous solution is contacted with one or more further cementation substrates, wherein residual precious metal if present in the precious metal-lean aqueous solution is recovered by deposition on the one or more further cementation substrates in the presence of the soluble reducing agent.

25. The process according to claim 1, wherein the cementation substrate is retained in a cementation reactor, and wherein separating the precious metal cementation product from the precious metal-lean aqueous solution comprises flowing the precious metal-lean aqueous solution out of the cementation reactor.

26. The process according to claim 1, wherein recovering the precious metal from the precious metal cementation product comprises at least one selected from treating the precious metal cementation product with acid to dissolve the base metal, retorting the precious metal cementation product, calcining the precious metal cementation product and smelting the precious metal cementation product.

27. A process for recovering precious metal from a precious metal-bearing solid material comprising at least one precious metal selected from gold and silver, the process comprising:
leaching the precious metal-bearing solid material with an aqueous lixiviant comprising thiosulfate to produce a leach solution comprising thiosulfate and precious metal;
introducing a soluble reducing agent to the leach solution in excess of any oxidants present in the leach solution;
contacting the leach solution with a cementation substrate comprising a metallic composition comprising a base metal, wherein the precious metal is reduced in the presence of the reducing agent and the cementation substrate so that reduced precious metal deposits on the cementation substrate to form a precious metal cementation product; and
separating the precious metal cementation product from a precious metal-lean leach solution comprising the thiosulfate.

28. A process according to claim 27, wherein the precious metal-bearing solid material is an ore or concentrate.

29. A process according to claim 27, further comprising recycling at least a portion of the precious metal-lean leach solution to form at least a portion of the aqueous lixiviant.

30. A process for recovering precious metal from a loaded absorbent comprising thiosulfate and at least one precious metal selected from gold and silver, the process comprising:
eluting the loaded absorbent with an aqueous eluant to produce an eluate comprising thiosulfate and precious metal;
introducing a soluble reducing agent to the eluate in excess of any oxidants present in the eluate;
contacting the eluate with a cementation substrate comprising a metallic composition comprising a base metal, wherein the precious metal is reduced in the presence of the reducing agent and the cementation substrate so that reduced precious metal deposits on the cementation substrate to form a precious metal cementation product; and
separating the precious metal cementation product from a precious metal-lean eluate comprising the thiosulfate.

31. A process according to claim 30, wherein the absorbent is a strong base ion-exchange resin.

32. A process according to claim 30, wherein the aqueous eluant comprises at least one selected from sulfite, bisulfite and metabisulfite.

33. The process according to claim 30, wherein the aqueous eluant comprises at least one displacement anion selected from trithionate, chloride, bromide, thiocyanate and nitrate.

34. A process according to claim 30, further comprising recycling at least a portion of the precious metal-lean eluate to form at least a portion of the aqueous eluant.
